(19) United States
(12) Patent Application Publication
(10) Pub. No.: US 2004/0124996 A1
(43) Pub. Date: Jul. 1, 2004

(54) Data transmission apparatus and method

(76) Inventor: James Andersen, Elgin, IL (US)

Correspondence Address: Michael D Lake, Wallenstein & Wagner, 53rd Floor, 311 South Wacker Drive, Chicago, IL, 60606, US

(21) Appl. No.: 10/333,998

(22) PCT Filed: Jul. 27, 2001
(86) PCT No.: PCT/US01/23646

(51) Int. Cl. G08C 15/00

(52) U.S. Cl. 340/870.38; 379/176

(57) ABSTRACT

This invention relates to data communication equipment (DCE), more specifically, high speed transmission of electronic data between data terminal equipment (DTE). The invention sets forth a method and a device for transmitting a voltage signal waveform as a series of current pulses onto, for instance, a communication line. The method requires converting an input voltage signal waveform to a current signal waveform and transmitting the resulting current pulses onto a communication line wherein a predetermined bias voltage is maintained.

### RELATED APPLICATIONS

This application is a continuation in part of U.S. patent application Ser. No. 09/455,276, filed on Dec. 6, 1999, and incorporated herein by reference. This application further claims the benefit of: U.S. Provisional Patent Application Serial No. 60/221,296, filed on Jul. 27, 2000, and incorporated herein by reference; U.S. Provisional Patent Application Serial No. 60/221,482, filed on Jul. 27, 2000, and incorporated herein by reference; and U.S. Provisional Patent Application Serial No. 60/223,015, filed on Aug. 4, 2000, and incorporated herein by reference.

### TECHNICAL FIELD

The present invention generally relates to a method and device for transmitting data over a transmission medium at high speeds. More specifically, the present invention relates to using variations in electrical current for representing and conveying data over a transmission medium or a wireless connection.

### BACKGROUND OF THE INVENTION

There are many modems on the market today for high speed data bit transmission on a twisted-pair of copper telephone lines. Constant demand for increased amounts of data bit transmission has generated the continual need for faster modems capable of transmitting and receiving greater amounts of data. While many high speed transmission techniques such as ADSL and HDSL have emerged in response to this technological demand, there continues to remain a demand for yet greater data transmission rates. In addition, it would be extremely advantageous if the technology incorporating the higher transmission rates were able to implement existing electrical communication infrastructure, i.e., twisted-pair telephone lines. An additional preference would allow for the transmission of these signals at lower power over greater distances without needing fewer or any repeaters to amplify the signal.

Conventionally, data transmission is sent via voltage signals that are susceptible to many factors that may adversely affect the quality and distance of the transmission. Some of these factors include: random distortion noise, inherent characteristics or poor physical condition of the transmission line, transmission line length, high frequency, attenuation and distortion effects. One common approach used to overcome some of these adverse affects is to increase the transmission power. Of course, the greater the distance, the greater the impedance and the likelihood of effects due to exposure to external noise sources. FCC regulations also limit frequency levels and power levels of transmission. Bridge taps and loading coils, present in phone line infrastructure also present significant impediments to voltage signal data transmission. Bridge taps tend to divide voltage signals hence weakening them. Loading coils tend to resist changes in voltage level hence degrading data characterized by voltage level.

The amount of data that can be transmitted is directly related to the number of quantization levels that a transmitter utilizes. Random distortion noise directly affects the amount of quantization levels. Attempting to increase a transmission rate by merely increasing the amount of quantization levels beyond that in which the data bits can be determined is not useful. To date, the limitations on quantization caused by random distortion noise has prevented conventional modems and transmission techniques from meeting the demand for higher data transmission speed.

Additionally, today's transmission lines incorporate repeaters that amplify a signal that has attenuated or weakened during its transmission. The repeater is necessary to re-amplify the affected signal. A transmission signal that is expected to travel a great distance must often be re-amplified repeatedly.

Hence, prior to the present invention, a need existed for a method of data transmission capable of better recognizing and discriminating a signal from accompanying noise. Also needed, were methods and apparatus for transmitting data signals which would avoid or significantly reduce the adverse effects of the factors cited above, so as to provide data transmissions of higher quality, increased capacity, and longer transmission distances at lower power with fewer, or no need for repeaters.

### SUMMARY OF THE INVENTION

This invention relates to data communication equipment (DCE), more specifically, a modem or wireless device capable of high speed transmission of electronic data between data terminal equipment (DTE). Broadly stated, this invention sets forth a method and a device for transmitting data as a series of current pulses onto a transmission medium such as a communication line or a wireless transmission medium. The method requires converting an input signal waveform to a current signal waveform and transmitting the resulting current pulses onto a communication line or an antenna wherein a predetermined bias voltage is maintained.

Transmitting data as current pulses is an improved method of transmitting data, as opposed to using voltage pulses, because current is not affected as much by capacitance. By virtue of Kirchoffs' Law, this allows the transmission of data over greater distances because the signal is less attenuated by line capacitance. With an increase in shunt capacitance and/or an increase in frequency across the capacitance, voltage data pulses weaken. Therefore, bridge taps associated with the current phone line infrastructure will not degrade the signals transmitted according to the invention to the same degree as they degrade (divide) conventional voltage signal waveforms. It is also known that loading coils exist in the infrastructure, are resistant to voltage changes, hence, the loading coils present a significant impediment to voltage waveform signals. On the other hand, it is believed that signals transmitted according to the present invention should be far less affected by loading coils.

Another embodiment of this invention includes a method of generating representative pulses of current from an input (either current or voltage) waveform and transmitting resulting current pulses onto a communication line. Another aspect of the invention includes receiving the current pulses, measuring the current pulses, and translating the measured current pulses into data.

A circuit for carrying out the method as it relates to transmitting standard voltage-based data, includes a converter for receiving voltage waveform input and generating a series of current pulses in response to the input voltage signal. A transmitter responsive to output of the converter is provided for transmitting the output onto a communication line terminated by a receiver.

Another embodiment of the invention provides an automatic system for adjusting series and shunt impedance of a transmitting system relative to changes in data and transmission medium by a circuit for measuring and correcting changes in series and shunt impedance of the line using references internal to the transmitter (voltage, current, impedance, and current range). A gain amplifier is used to control changes in impedance and signal current. Output voltage is kept at a reference level while output current is varied thereby controlling the impedance of the transmitter. The transmitter has a current source for supplying reference currents and a voltage source for supplying reference voltages and a gain controlling circuit for controlling a current signal within a range of values according to binary input data.

A common problem of other known modems is the deterioration of the transmission signal due to distortion effects over the transmission line. In effect, the transmission signal is not able to be identified because of the accompanying noise distortion. This invention is able to transmit significantly greater amounts of data than previous methods because it discriminates transmitted data from random distortion noise existing on the communication line.

A primary advantage of this invention is the provision of significantly increased amounts of data by being able to transmit and receive a low voltage signal amidst the accompanying random distortion noise and interference that was generally thought to be indeterminable.

A further advantage of this invention is the provision of significantly increased lengths of transmission than currently thought capable without the use of repeaters or amplifiers.

Another aspect of this invention is to transmit data at a low voltage and to further maintain this low voltage by monitoring and adjusting the current associated with the data signal.

It is further contemplated that the transmitter step of monitoring and adjusting the current includes the step of transmitting at least one reference/calibration pulse over the communication line and measuring the effects of line impedance on the current pulse.

These and other features of the present invention are discussed or apparent in the following detailed description.

### BRIEF DESCRIPTION OF THE DRAWINGS

FIG. 1 is a schematic diagram, in block diagram form, of a preferred embodiment of a device incorporating an automatic impedance tuner in accordance with the present invention coupled to a receiver via a communication line;

FIG. 2 is a partial simplified schematic diagram of the embodiment depicted in FIG. 1 including a converter, filter/regulator, amplifier and transmitter;

FIG. 3 is a graphical depiction of the modulated output of the converter of FIG. 2 after being partially modified by the filter/regulator;

FIG. 4 is a partial schematic of an alternative embodiment of the transmitter of FIG. 2;

FIG. 5 is a simplified block diagram of a system in accordance with the present invention including a data transmitter device, a transmission medium and a receiver;

FIG. 6 is a schematic diagram of an embodiment of the transmission medium shown in FIG. 5;

FIG. 7 is a schematic diagram of an alternative embodiment of the transmission medium shown in FIG. 5;

FIG. 8 is an expanded block diagram of the data transmitter device of FIG. 5 including a data generator connected to a transmitter;

FIG. 9 is an expanded block diagram of the data generator shown in FIG. 8 comprising a bit generator and a modulator;

FIG. 10 is a schematic diagram of an embodiment of a bit generator shown in FIG. 9;

FIG. 11 is a schematic diagram of an alternative embodiment of a bit generator shown in FIG. 9;

FIG. 12 is a schematic diagram of the modulator shown in FIG. 9;

FIG. 13 is a schematic diagram of the transmitter shown in FIG. 8;

FIG. 14 is a schematic diagram of a receiver shown in FIG. 5, the receiver comprising an input network, output network, amplifier IC1, amplifier IC2, and amplifier IC3;

FIG. 15 is an expanded schematic diagram of the input network shown in FIG. 14;

FIG. 16 is an expanded schematic diagram of the output network shown in FIG. 14;

FIG. 17 is an expanded schematic diagram of amplifier IC1 shown in FIG. 14;

FIG. 18 is an expanded schematic diagram of amplifier IC2 shown in FIG. 14;

FIG. 19 is an expanded schematic diagram of amplifier IC3 shown in FIG. 14;

FIG. 20 is a simplified diagram of a system in accordance with the present invention for transmitting and receiving data via a transmission medium;

FIG. 21 is a waveform diagram depicting a preferred embodiment of a pair of signals transmitted across the tip and ring signal paths of FIG. 20, each signal includes a carrier signal having a plurality of bit signals modulated thereon;

FIG. 22 is a waveform diagram depicting a preferred embodiment of the carrier signal depicted in FIG. 21;

FIG. 23 is a simplified block diagram of another system in accordance with the present invention for transmitting and receiving data via a transmission medium;

FIG. 24 is a simplified expanded block diagram of the system depicted in FIG. 23, the system including both digital and analog circuit portions;

FIG. 25 is a simplified expanded block diagram of the digital circuit portion shown in FIG. 24;

FIG. 26 is a circuit diagram of the data interface block shown in FIG. 25;

FIG. 27 is a circuit diagram of the address map control block shown in FIG. 25;

FIG. 28 is a circuit diagram of the memory block shown in FIG. 25;

FIG. 29 is a circuit diagram of the address map select block shown in FIG. 25;

FIG. 30 is a circuit diagram of the control block shown in FIG. 25;

FIG. 31 is a simplified expanded block diagram of the analog circuit portion shown in FIG. 24;

FIG. 32 is a circuit diagram of the modulator shown in FIG. 31;

FIG. 33 is a circuit diagram of the transmitter shown in FIG. 31;

FIG. 34 is a circuit diagram of the receiving input network shown in FIG. 31;

FIG. 35 is a circuit diagram of the analog circuit connected between the receiving input network and the receiving output network shown in FIG. 31;

FIG. 36 is a circuit diagram of the other analog circuit connected between the receiving input network and the receiving output network shown in FIG. 31;

FIG. 37 is a circuit diagram of the receiving output network shown in FIG. 31;

FIG. 38 is a circuit diagram of the analog circuit connected to the receiving output network shown in FIG. 31;

FIG. 39 is a circuit diagram of the transmit/receive gate connected to the transmitter shown in FIG. 31;

FIG. 40 is a circuit diagram of the other transmit/receive gate connected to tip and ring signal transmission leads;

FIG. 41 is a block diagram of an error correction system suitable for use with the present invention;

FIG. 42 is a block diagram of another embodiment of an error correction system suitable for use with the present invention;

FIG. 43 is a block diagram with tip and ring independently processed through a system and wherein a virtual ground provides for current differential measurements;

FIG. 44 is a schematic diagram depicting a virtual direct connect system that establishes a series impedance mismatch to create a counterweight effect that is used for balancing;

FIG. 45 is a graph of the counterweight effect and how the bits are effectively drawn towards the higher impedance at the receiver;

FIG. 46 is a schematic diagram depicting the total series impedance of 2.4K prior to any changes occurring on the medium;

FIG. 47 is a schematic diagram depicting how an embodiment of the present invention reacts to changes in the medium;

FIG. 48 is a graph of an embodiment of a waveform transmitted over the medium;

FIG. 49 is a graph wherein impulses of current are encoded onto the wave of FIG. 48;

FIG. 50 is a graph depicting in an embodiment how the bits and entire waveform are sent in duplicate;

FIG. 51 is an embodiment of a line encoding scheme in accordance with the present invention;

FIG. 52 is a diagram comparing a data channel driven by a current source and a voltage source;

FIG. 53 are graphs comparing energy by driving data with a current source verses a voltage source;

FIG. 54 is a diagram depicting the output of a differential circuit for eliminating interference;

FIG. 55 is a chart depicting a one-insertion (X) on the RING;

FIG. 56 is a preferred embodiment of a cell data transport frame;

FIG. 57 is a preferred embodiment of a bulk data transport frame;

FIG. 58 is a preferred embodiment of OAM management messages;

FIG. 59 is a preferred embodiment of an OAM startup message;

FIG. 60 is a preferred embodiment of an OAM termination message;

FIG. 61 is a diagram illustrating frame termination to TRUE silence;

FIG. 62 is a diagram illustrating signals between frames;

FIG. 63 and 64 are a preferred embodiment for performing slope detection;

FIG. 65 is a preferred embodiment of the counters to be kept for interrogation by network managing elements;

FIG. 66 is a simplified diagram of an antenna of a system in accordance with the present invention for transmitting and receiving data via a wireless connection;

FIG. 67 is a simplified block diagram of a wireless transceiver in accordance with the present invention;

FIG. 68 is a simplified block diagram of the system shown in FIG. 67;

FIG. 69 is a simplified block diagram of an analog circuit;

FIG. 70 is a circuit diagram of the modulator shown in FIG. 68;

FIG. 71 is a circuit diagram of the transmitter shown in FIG. 68;

FIG. 72 is a circuit diagram of the receiving input network shown in FIG. 68;

FIG. 73 is a circuit diagram of the analog circuit connected between the receiving input network and the receiving output network shown in FIG. 68;

FIG. 74 is a circuit diagram of the other analog circuit connected between the receiving input network and the receiving output network shown in FIG. 68;

FIG. 75 is a circuit diagram of the receiving output network shown in FIG. 68;

FIG. 76 is a circuit diagram of the analog circuit connected to the receiving output network shown in FIG. 68;

FIG. 77 is a circuit diagram of the transmit/receive gate connected to the transmitter shown in FIG. 68;

FIG. 78 is a circuit diagram of the other transmit/receive gate connected to the antenna of FIG. 68;

FIG. 79 is a block diagram of a system for controlling the system depicted in FIG. 68; and

FIGS. 80-84 are circuit level diagrams for implementing the system depicted in FIG. 79.

### DETAILED DESCRIPTION OF THE PREFERRED EMBODIMENT

While this invention is susceptible of embodiments in many different forms, there is shown in the drawings and will herein be described in detail, preferred embodiments of the invention with the understanding that the present disclosure is to be considered as an exemplification of the principles of the invention and it is not intended to limit the broad aspects of the invention to the embodiments illustrated.

Referring to FIG. 1, an automatic impedance tuner 5 is depicted having a converter/filter 10, filter/regulator 12, amplifier 14, and transmitter 16. The converter/filter 10 receives a digital voltage pulse signal 8 representing data. The input signal 8 is transformed by the converter 10 into a phase modulated current output 40 that is received by the filter/regulator 12.

The filter/regulator 12 measures current change, limits the voltage range of the phase modulated current output 40, and dampens ringing on the signal. In addition, the filter/regulator 12 differentiates the phase modulated current output 40, adjusts for current gain and narrows the current pulses of the phase modulated current output 40. Before being received by the amplifier 14, the differentiated signal output 55 generated by the filter/regulator 12 is widened and returned to a timing similar to input data signal 8.

The transmitter 16 adjusts the amplified current signal 57 generated by the amplifier 14 in response to filter/regulator 12. Accordingly, the transmitter 16 provides a desired voltage and current for transmission to a receiver 20 via communication line 18. Receiver 20 deciphers the transmission by detecting variations in the current received from the transmitter 16.

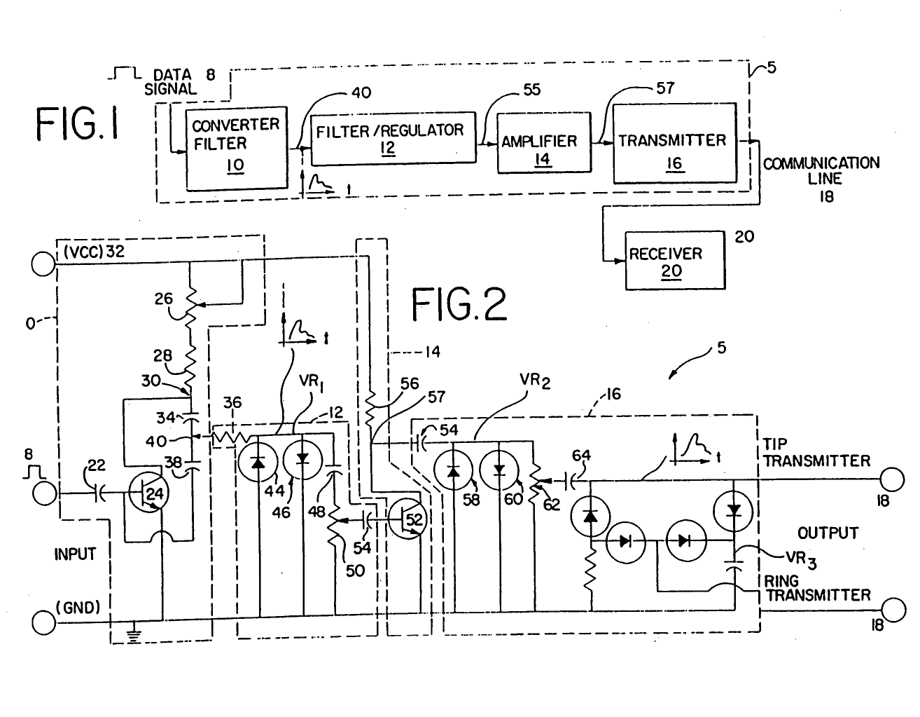

Referring to FIG. 2, a further defined schematic diagram of a preferred embodiment of an automatic impedance tuner 5 in accordance with the present invention is provided. The tuner 5 includes the converter/filter 10, filter/regulator 12, amplifier 14, and transmitter 16 of FIG. 1. Accordingly, the same reference numbers are used, where appropriate, within both FIGS. 1 and 2.

The converter/filter 10 includes a common emitter transistor 24, a filter capacitor 22, two coupling feedback capacitors 34, 38, and two current limiting resistors 26, 28. The input voltage pulse signal 8 received by the converter/filter 10 is filtered by capacitor 22 connected to the base of the first common-emitter transistor 24. In part, the transistor operates as a cutoff circuit for keeping a sharp rise and fall time of the converter output 40, and thus the output of the tuner 5. Also, the first common-emitter transistor 24 provides a constant current reference through serially connected resistor 28 and adjustable resistor 26 wherein resistor 26 is coupled to a regulated power source 32 of about 8 volts and resistor 28 is attached to the collector 30 of the transistor. Preferably, the voltage potential at the collector 30 of the first common-emitter transistor 24 is approximately one-half the value of the voltage potential of the power source 32 with respect to ground, i.e., 4 volts. The collector 30 of the first common-emitter transistor 24 is fedback to its base through the two capacitors 34, 38 which are coupled together in series and operably connected at the junction of the capacitors to the output of the tuner 5. This internal feedback controls the automatic impedance tuner's 5 current output relative to the load on the communication line 18 and the power source 32. The coupling feedback capacitors 34 and 38 preferably are in a 2.2 to 1 ratio to modulate the input voltage signal 8 into a converted constant current signal received by the filter/regulator 12. As a result of the charging and discharging of the capacitors 34 and 38, the magnitude of each current pulse provided by the output 40 of the converter/filter 10 quickly rises to a peak, then falls to a plateau that is maintained for a time duration before the current magnitudes falling off rapidly.

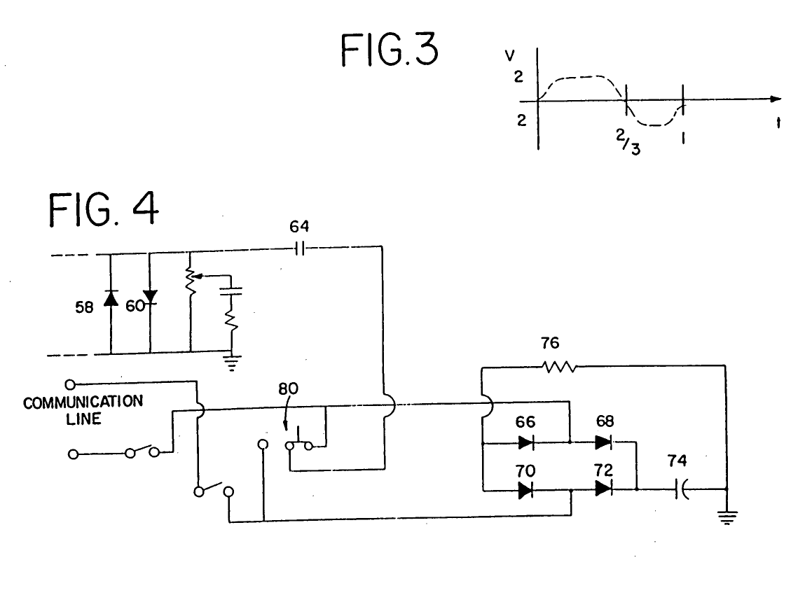

Coupled to the converter's output 40 is the filter/regulator 12 comprising an AC and DC load that includes the load of the communication line 18. The filter/regulator 12 consists of a measuring resistor 36, a pair of clamping diodes, 44, 46, a filter capacitor 54 and a differentiator. At the input of the filter/regulator 12, the measuring resistor 36 is coupled between a pair of clamping diodes 44, 46, preferably geranium. In particular, the resistor 36 is connected to the cathode of diode 44 and the anode of diode 46. Moreover, the anode of diode 44 and the cathode of diode 46 are attached to ground. These diodes 44, 46 are used to reduce noise on the converted output signal 40 by dampening voltage ringing and oscillations. The diodes 44, 46 clamp the converted data signal to a voltage level between 0.2 and −0.2 volts, or 0.4 volts peak-to-peak as shown in FIG. 3. Moreover, a reference voltage range VR1 is maintained at the junction between the diodes 44 and 46.

In addition, the majority of the load provided by the filter/regulator 12 is AC. Part of the DC load of the filter/regulator 12 is fixed by the measuring resistor 36 and the pair of diodes 44, 46. This fixed DC load is used as a reference load.

The data signal 40 also is differentiated within the filter/regulator 12 wherein the pulses of the received signal are narrowed. The differentiator is preferably comprised of a capacitor 48 in series with an adjustable resistor 50 for adjusting the output AC current level of the automatic impedance tuner 5 relative to the power source 32. The pulses of the data signal are widened and returned to a timing similar to the original signal 8 by filter capacitor 54. Moreover, resistor 50 provides for adjusting current gain.

The differentiated current signal 55 from the filter capacitor 54 of the filter/regulator 12 is received by the amplifier 14 which includes a second common-emitter transistor 52 for amplifying the differentiated current signal and a voltage limiting pull-up resistor 56 for limiting the voltage at the collector of the second common-emitter transistor 52. Preferably, the collector has a voltage of about 6 volts (i.e., close to the threshold turnoff) and is coupled to the transmitter 16. Via capacitor 64, the switching of shunt transistor 52 is effected by changes in the voltage at the tip transmitter 18 for maintaining a substantially constant voltage level at the tip transmitter.

The transmitter 16 includes a coupling capacitor 54, a pair of clamping diodes 58, 60 and a resistor-capacitor 62, 64 combination. The coupling capacitor 54 at the input of the transmitter 16 is attached to the output of the amplifier 14. The coupling capacitor 54 widens the pulses of the amplified current signal 57. Coupled between the filter capacitor 54 and the adjustable resistor 62 are two clamping diodes, 58, 60, preferably of type silicon, for maintaining the amplified current signal 57 within a voltage range VR2 between 0.7 and −0.7 volts, 1.4 volts peak-to-peak. The adjustable resistor 62 controls the voltage level and the AC current through a capacitor 64 while the two clamping diodes 58, 60 control the DC offset relative to ground. The adjustable resistor 62 and capacitor 64 adjust the voltage level on the communication line to approximately 1 volt, peak-to-peak. Prior to reaching the communication line, a diode-capacitor combination filters the AC portion of the signal from negative going noise spikes and a diode-resistor combination filters the DC portion of the signal from positive going noise spikes.

In an alternative embodiment, depicted in FIG. 4, the collector of the second common-emitter transistor 52 within the transmitter 14 is attached to two capacitors 54, 64 in series and then to a line-side select switch 80. Signal transmission can be placed on either the Tip 4 or the Ring 5 lines of the twisted copper pair of wiring, however, use of the Tip 4 line is preferred. Use of a line-side select switch 80 is connected to the junction of two diodes, 70, 72. If the Tip 4 line is going to be used as the output, a diode 72 and a capacitor 74 filter the AC portion of the signal from negative going noise spikes. A diode 70 and a resistor 76 are used to filter the DC portion of the positive going noise spikes. If the Ring 5 line is going to be used as the output, then a diode 68 and capacitor 74 are used to filter the AC portion of the signal from negative going noise spikes while another diode 66 and a resistor 76 filter the DC portion of the positive going noise spikes.

Turning to FIG. 5, a simplified block diagram is depicted of a system in accordance with the present invention. The system 110 includes a data transmitter device 112, a data transmission medium 114, and a data receiver 116. The data receiver 116 receives data signals transmitted from the transmitter 112 across the transmission medium 114.

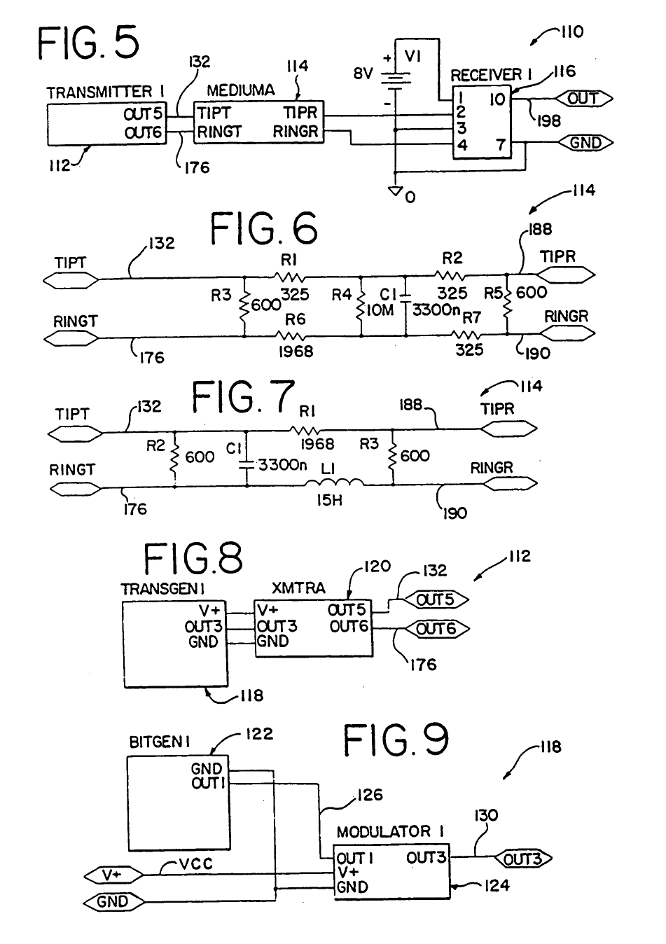

In FIG. 6, the transmission medium 114 is modeled to provide conventional characteristics found in telephone transmission cables or the like that do not include a significant amount of inductance. The transmission medium receives input signal pair 132 and 172 and provides corresponding output signal pair 188 and 190. In an alternative embodiment shown in FIG. 7, the transmission medium 114 can be modeled to provide characteristics found in transmission mediums having, for example, about 15 mH of inductance as found in many conventional preexisting transmission mediums.

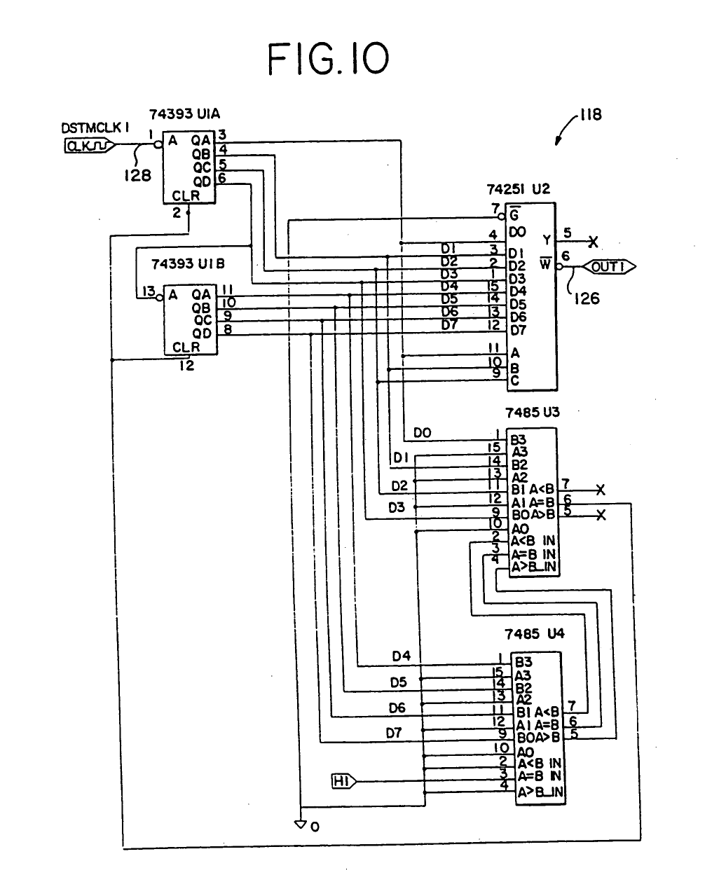

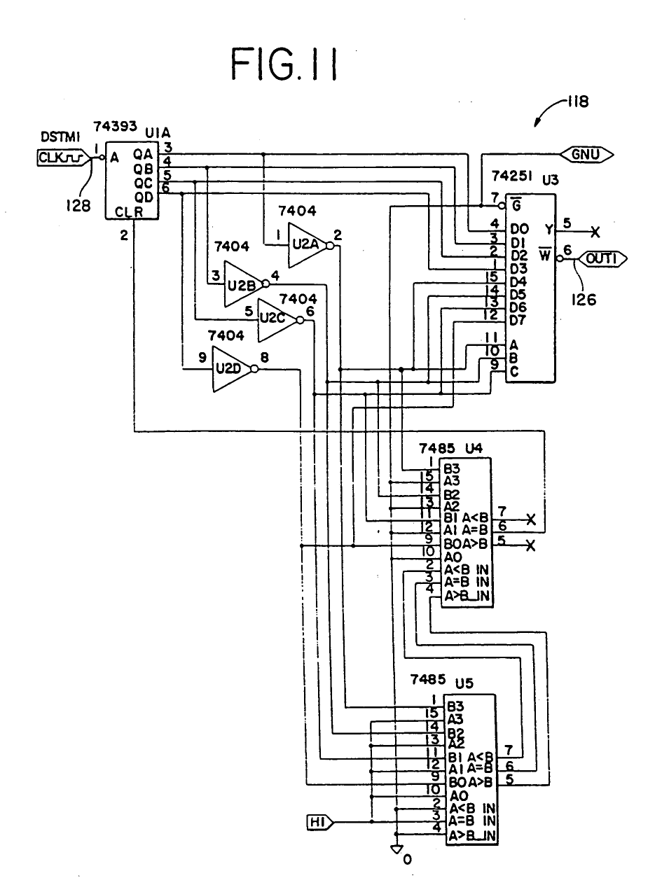

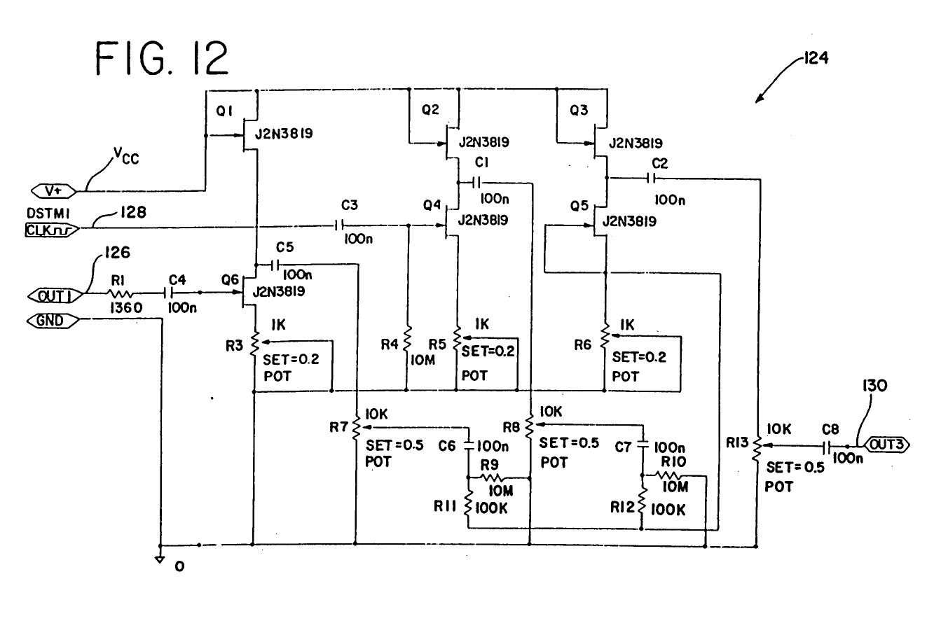

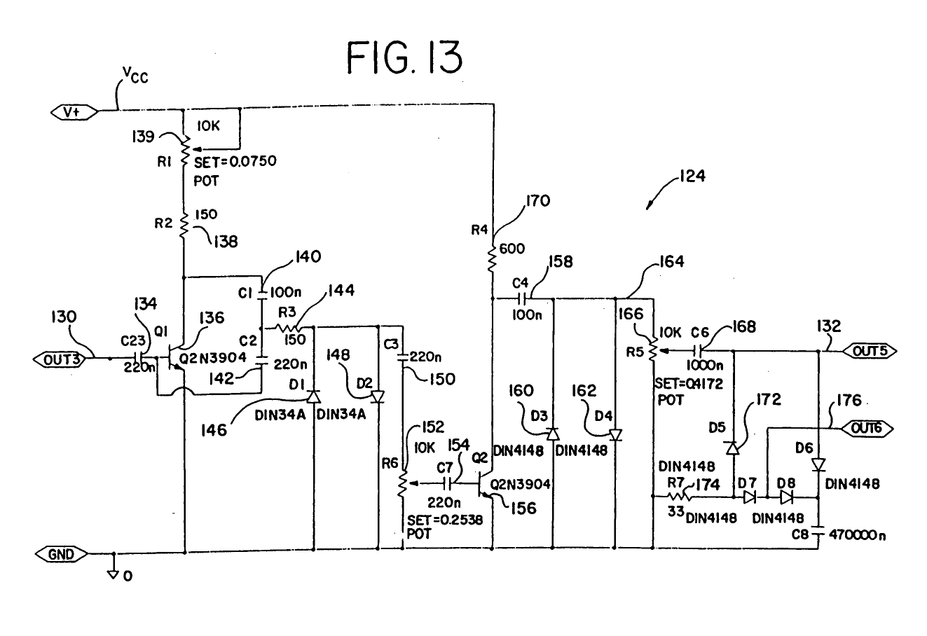

As shown in FIG. 8, the data transmitter 112 preferably includes a data generator 118 and a transmitter 120 operably coupled together. In a preferred embodiment shown in FIG. 9 for testing the circuitry, the data generator 118 includes a bit generator 122 and a modulator 124. The bit generator 122 provides a data signal 126 represented as a series of voltage pules preferably in the range of about 0 to 5 volts. As shown in FIG. 10, the bit generator 122 can consist of a counting circuit responsive to a digital reference clock signal 128 wherein a series of digital data signals 126 are provided corresponding to binary numeric values and increasing in binary numeric magnitude at a constant incremental rate. Alternatively, in another embodiment for testing shown in FIG. 11, the bit generator 122 can consist of a counting circuit responsive to a digital reference clock signal 128 for providing digital data signals 126 corresponding to numeric values and decreasing in binary numerical magnitude at a constant incremental rate.

As shown in FIG. 12, the digital data signals 126 from the bit generator 122 along with digital reference clock signal 128 are received by the modulator 124. In response to these signals, the modulator 124 generates a modulated digital data signal 130 comprising the digital data signals 126 added to the clock signal 128.

The modulated digital signals 130 are received by the transmitter 124 for conversion and transmission across the transmission medium 114 to the receiver 116. As shown in FIG. 13, the transmitter 124 is similar to that shown in FIG. 2 and described above. In particular, the transmitter 124 receives the digital signals 130 and converts them into current pulses while maintaining a substantially constant voltage level on the output 132. Preferably, the voltage level is about 1 volt.

In particular, the digital signals 130 are fed to the capacitor 134 attached to the base of transistor 136. This transistor 136 is a constant current reference through resistor 138 and adjustable resistor 139 to Vcc, preferably about +8 V. The transistor 136 has feedback from it's collector to it's base through two capacitors 140 and 142 in series. This controls the transmitter current relative to the load and Vcc. At the junctions of capacitors 140 and 142 is an AC and DC load including the line, which the majority of the load being AC. Part of the DC load at this junction is fixed by a resistor 144 and diodes 146 and 148. The fixed DC load is used as a reference load. The diodes 146 and 148 clamp the peaks to 0.7 V positive and negative going resulting in a 1.4 V peak to peak output. The junction of 144, 146 and 148 goes to a capacitor 150 and then to an adjustable resistor 152. This adjustable resistor 152 adjusts the output AC current level of the transmitter 124 relative to Vcc then goes to a capacitor 154 and then to the base of a transistor 156. The transistor's collector goes to capacitor 158 coupled to diodes 160 and 162 for clamping the peaks to 0.7 v positive and negative going resulting in a 1.4 V peak to peak output 164. Also attached to the output 164 is an adjustable resistor 166 for controlling the voltage level and the AC current through a capacitor 168. The collector of transistor 154 also is coupled to a resistor 170 attached to Vcc for limiting the voltage that the transistor will reach when fully turned on. Furthermore, serial connected diode 172 and resistor 174 are coupled between ground and output 132 for filtering the DC portion of positive going noise spikes.

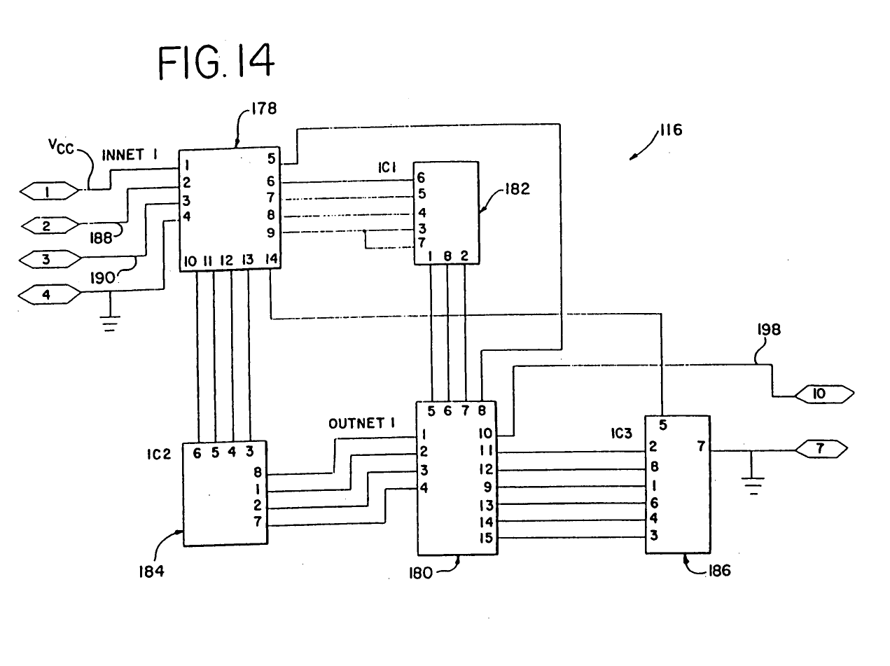

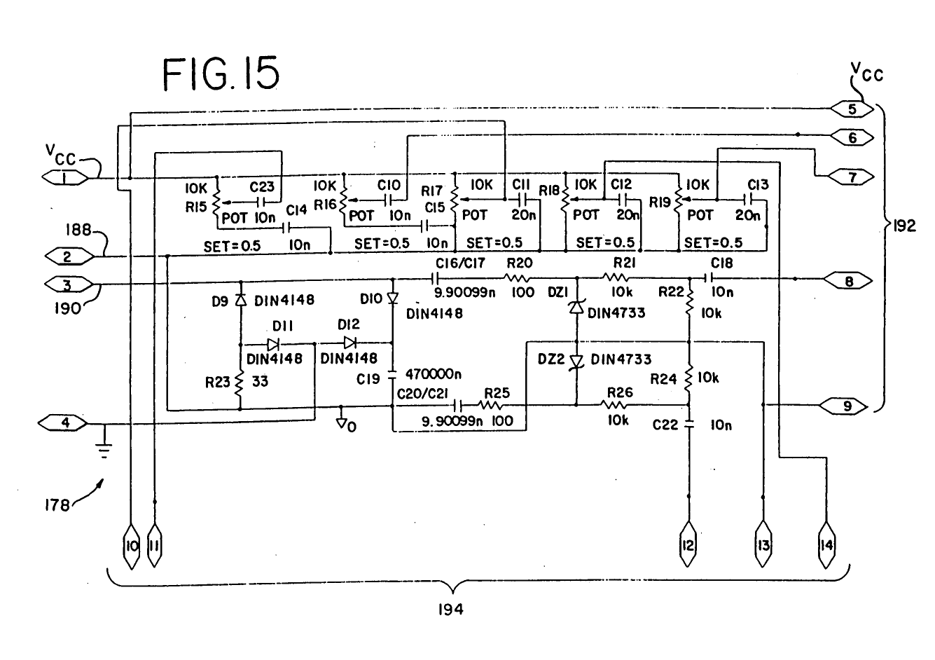

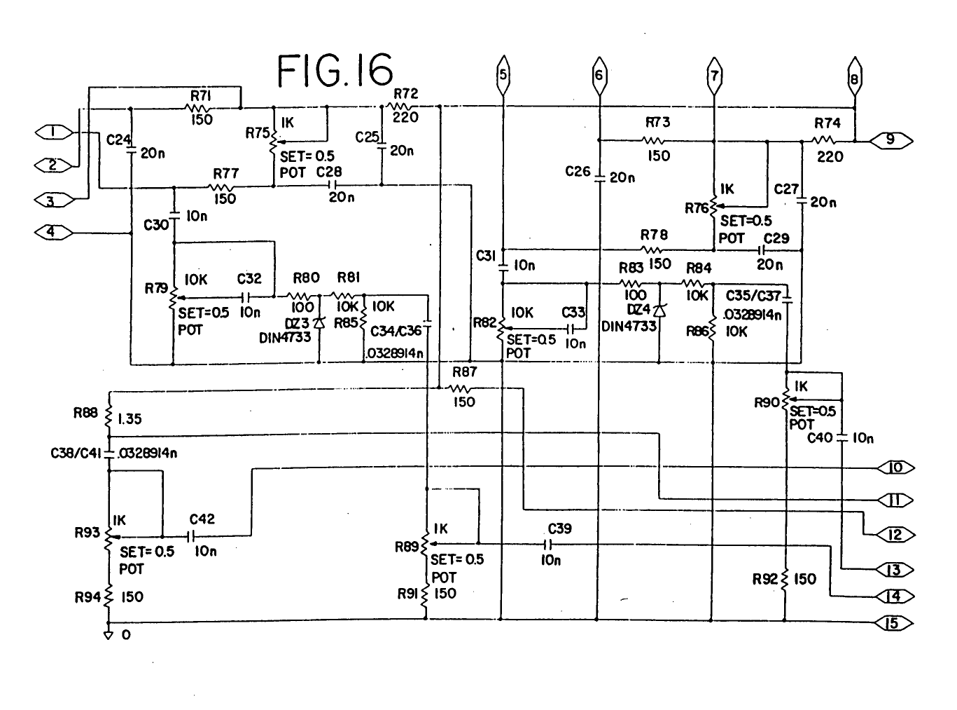

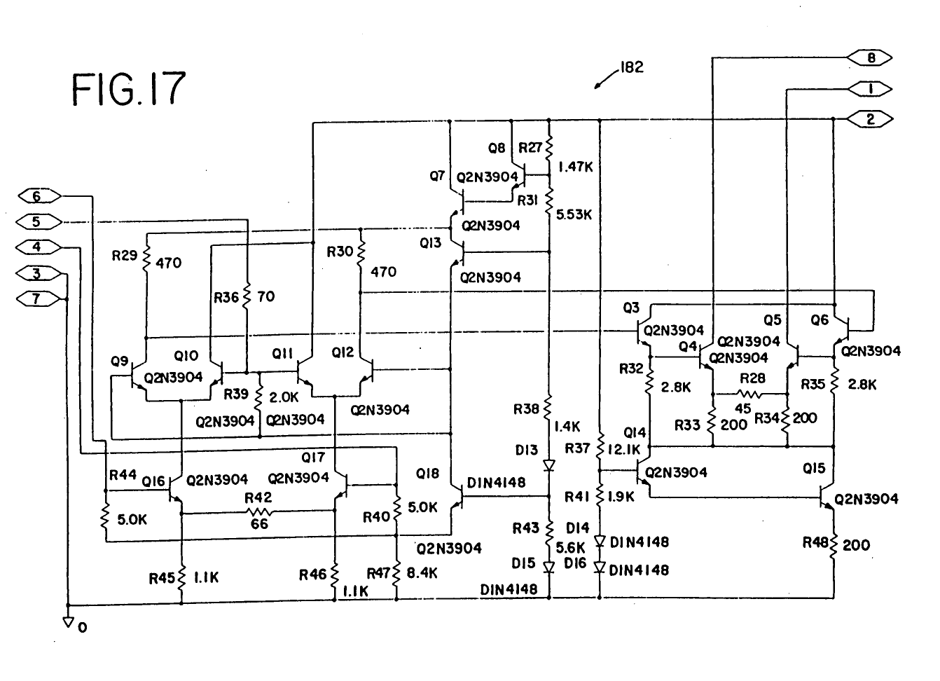

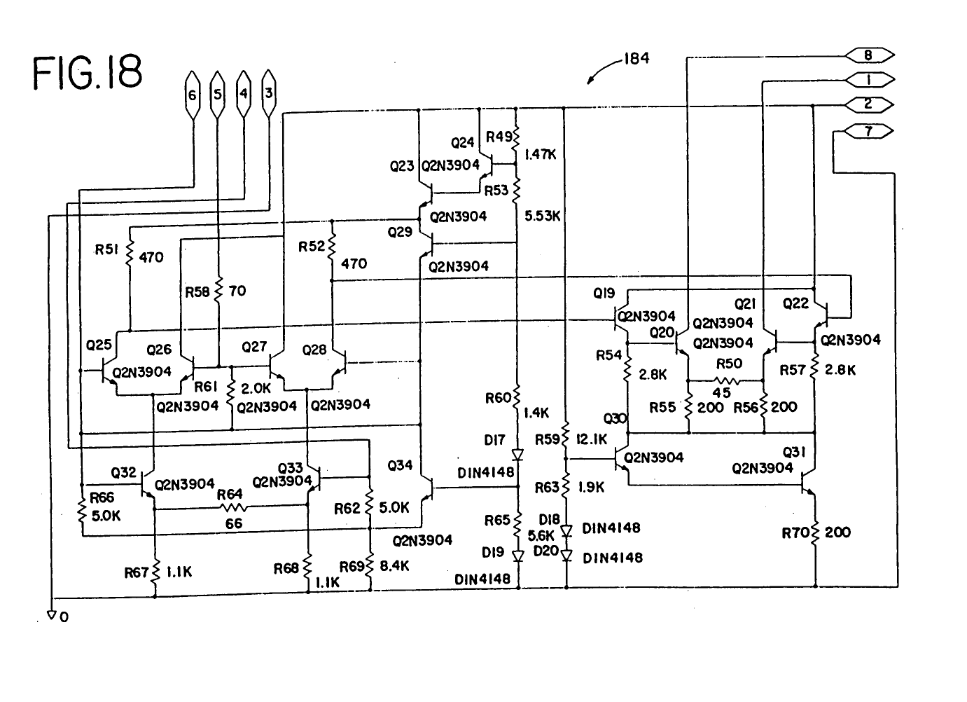

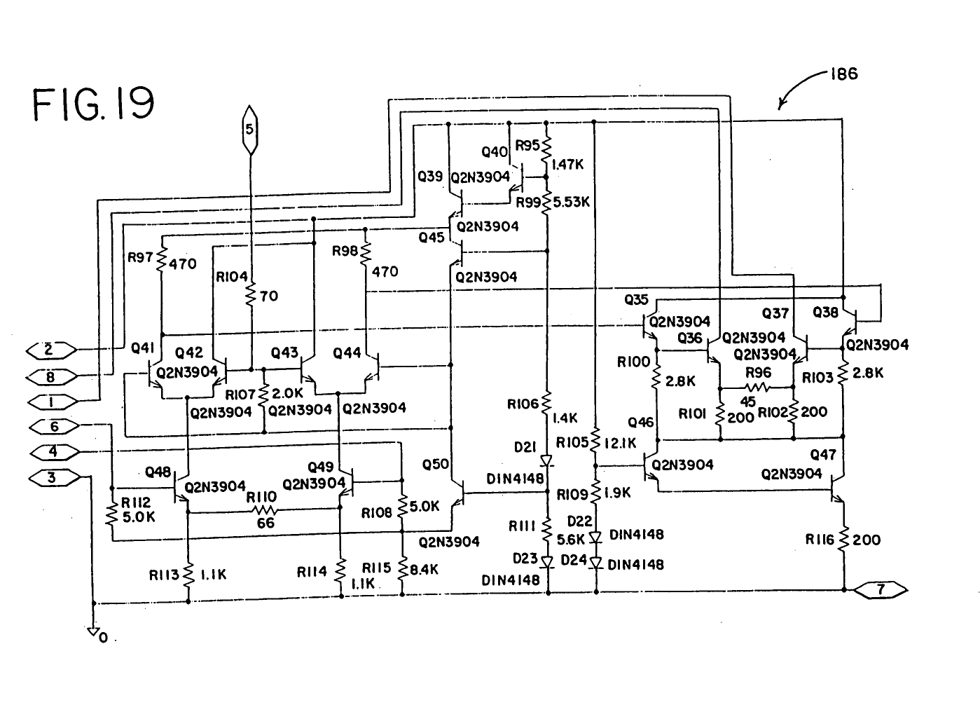

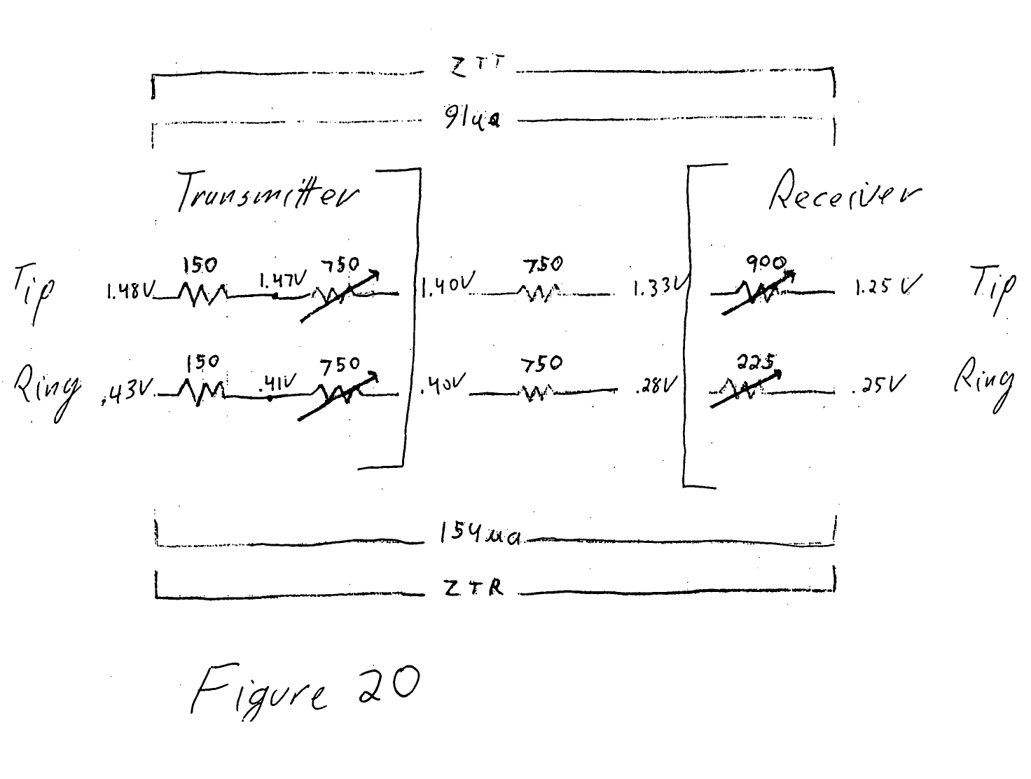

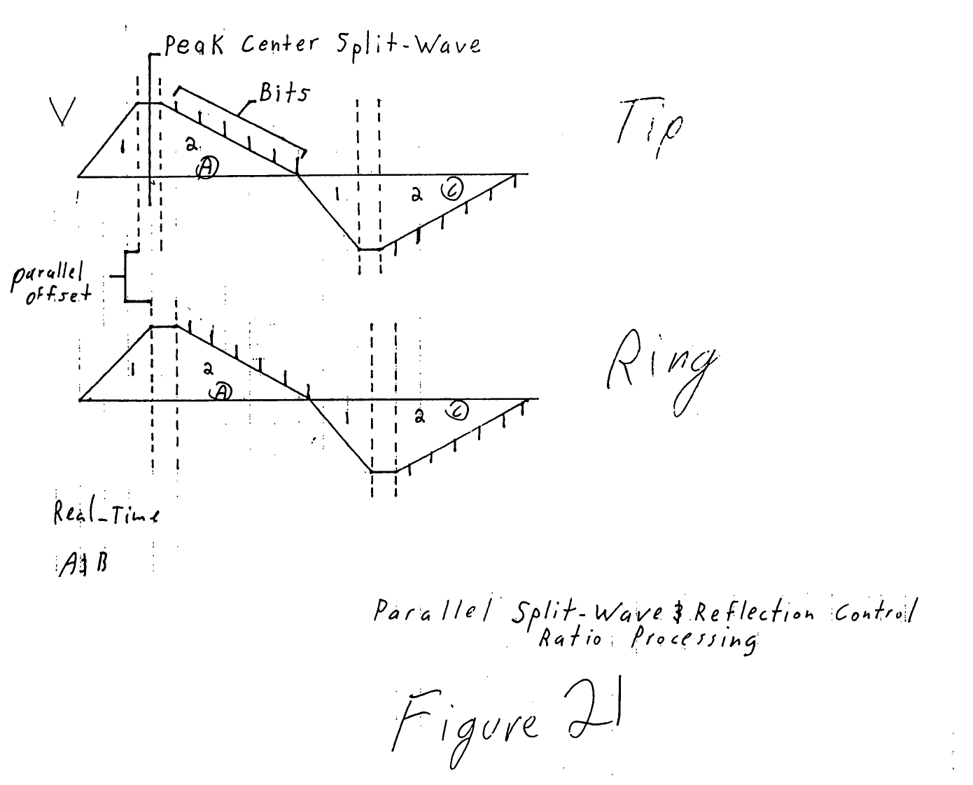

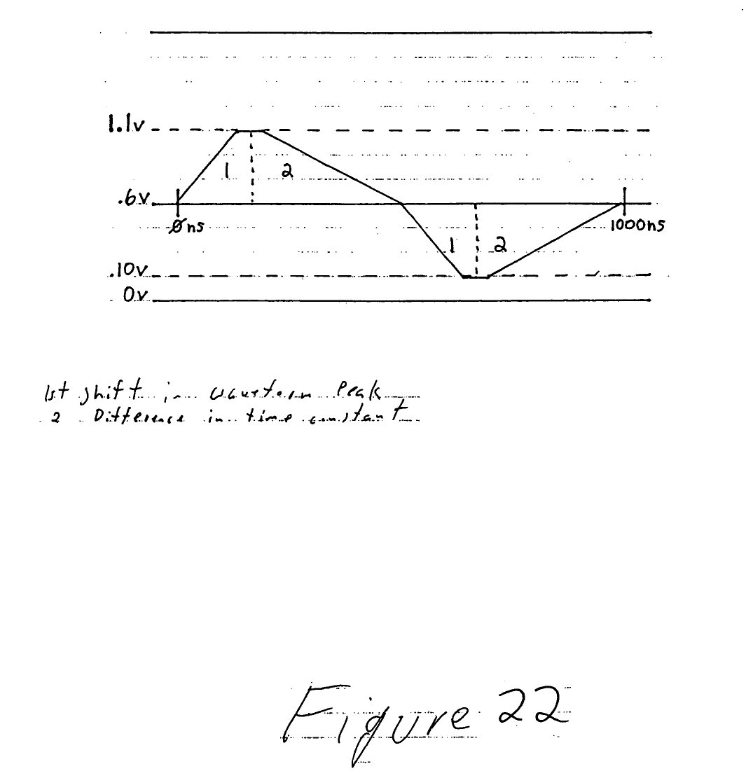

As shown in FIG. 14, the receiver 116 includes an input network 178, an output network 180, and a plurality of integrated IF amplifiers 182, 184, and 186. Referring to FIGS. 5 and 16, TIP and the RING signals 132 and 136 are transmitted across the transmission medium 144 and the input network 178 receives corresponding TIP and RING signals 188 and 190, respectively. In response to signals 188 and 190, the input network 178 filters out noise to provide filtered data output signal groups 192 and 194.

The filtered signal groups 192 and 194 are received by IF amplifiers 182 and 184, respectively, for amplifying the signals and passing them to the output network 180 where the signals are mixed together and amplified by amplifier 186 to produce a noise reduced digital data output signal 196 corresponding to the digital data input 126 from the data generator 122.

Twisted-pair phone lines are disclosed as a preferred embodiment only due to their prevalence in the global telecommunication infrastructure. It is contemplated that advantages may be had employing the basic concepts of the invention in transmission of data over shielded coaxial cable lines, category 5 lines, twisted-pair copper lines, etc. It is even contemplated that the present invention may be advantageously employed with wireless communication mediums such as broadcast in air, since signal attenuation, concerns also apply to this transmission medium. “Transmission medium,” as used herein relates to a communication line or an electromagnetic signal path from a first device to a second device being physically and spatially remote from the first. “Communication line” as used herein relates only to one or more conductors and the like used for transmitting data from a first device to a second device being physically and spatially remote from the first. “Remote,” means, that neither the first nor the second device share the same chassis, housing, or support structure. In its most concrete and conventional form, remote would contemplate one modem communicating with another over conventional telecommunication lines, although it is not intended to be so limited. In short, the present invention addresses data transmission problems presently faced by telecommunications industry, Internet, and local area networks in communication between remote devices.

Presently it is believed that one of the most needed areas for the invention is for data transmission along a “communication line” from homes and businesses to and from a telecommunications central switching office (“CO” or “switching office”). This is where a bulk of the twisted-pair copper communication line infrastructure is deployed.

Turning to FIG. 20, a simplified diagram of another embodiment of a system in accordance with the present invention is depicted. The system includes a data transmitter device, a data receiver device, and a transmission medium connected therebetween. The transmission medium can comprise a conventional telephone transmission cable having tip and ring transmission paths. However, in an embodiment, the transmission medium can comprise a single transmission path or communication line.

In an embodiment, the transmitter provides a reference voltage potential of about 1.48 volts operably connected to a termination resistor of about 150 ohms. The termination resistor is attached to a variable control impedance that is operably connected to the tip transmission path having a line impedance of about 750 ohms.

The receiver provides a reference voltage potential of about 1.25 volts operably connected to a variable impedance coupled to the tip transmission path. Preferably, the total serial impedance provided by the transmitter, tip transmission path, and the receiver is substantially constant and is maintained by automatic control of the receiver and transmitter variable control impedances.

However, signals corresponding to data are generated on the tip transmission path by the transmitter varying the impedance value of the transmitter's variable impedance in response to voltage control signals, such as data signals, received by the transmitter. The changes in the impedance value result in corresponding changes in the magnitude of the current flowing from the transmitter, to the receiver, via the tip transmission path. These current magnitude changes are detected by the receiver and converted into voltage signals corresponding to the data received. Preferably, changes in the current magnitude are detected by the receiver between the tip transmission path and the receiver's variable control impedance.

If desired, phase shifted error checking data or additional data can also be transmitted on the ring transmission path. In an embodiment, the transmitter provides a reference voltage potential of about 0.48 volts operably connected to a termination resistor of about 150 ohms. The termination resistor is connected to a variable control impedance that is attached to the ring transmission path having a line impedance of about. 750 ohms.

The receiver provides a reference voltage potential of about 0.25 volts operably coupled to a variable impedance attached to the ring transmission path. Preferably, the total serial impedance provided by the transmitter, ring transmission path, and the receiver is substantially constant and is maintained by automatic control of the receiver and transmitter variable control impedances.

However, signals corresponding to voltage data signals received by the transmitter are generated on the ring transmission path by varying the impedance of the transmitter's variable impedance. The changes in the impedance result in corresponding changes in the magnitude of the current flowing, via the ring transmission path, from the transmitter to the receiver. These current magnitude changes are detected by the receiver and converted back into voltage data signals. Preferably, changes in the current magnitude are detected by the receiver between the ring transmission path and the receiver's variable control impedance.

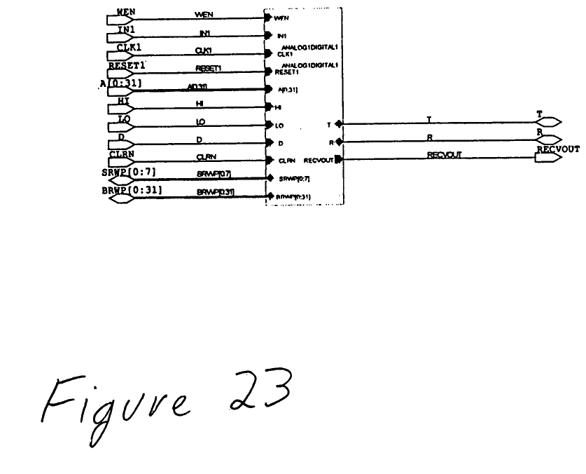

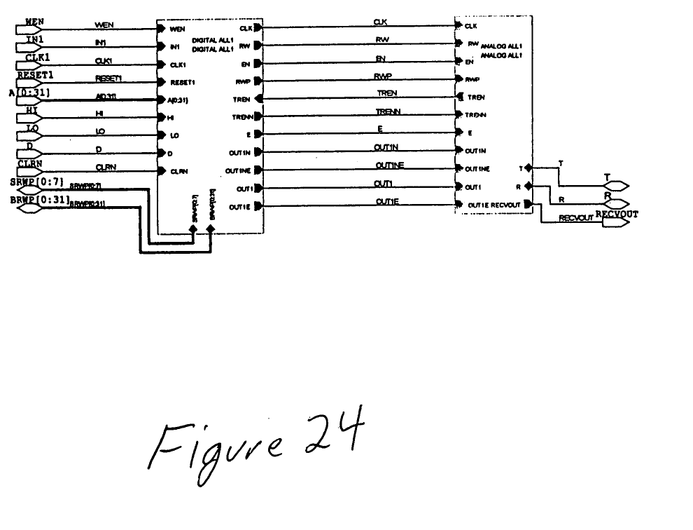

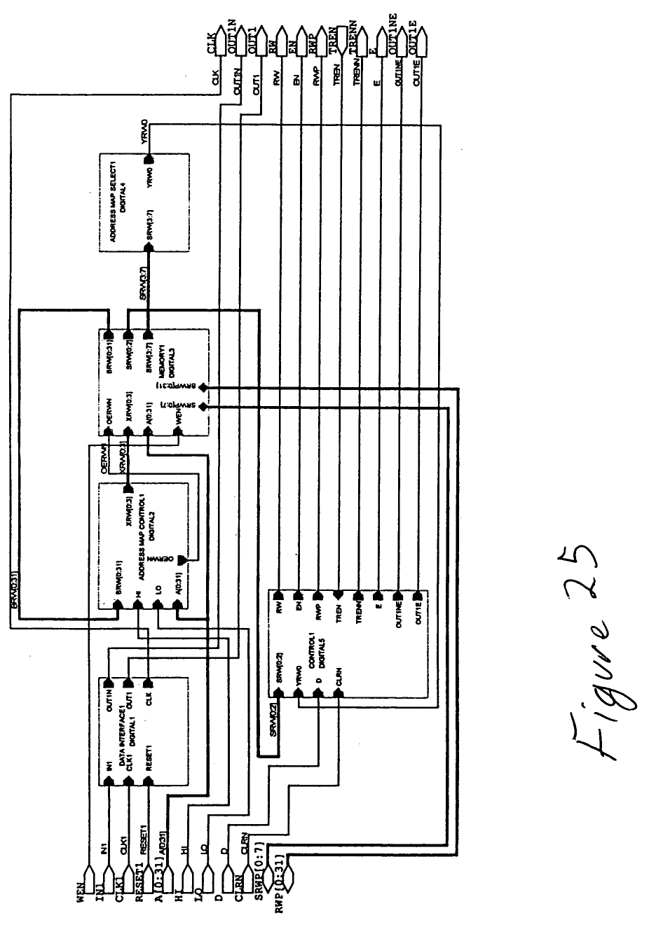

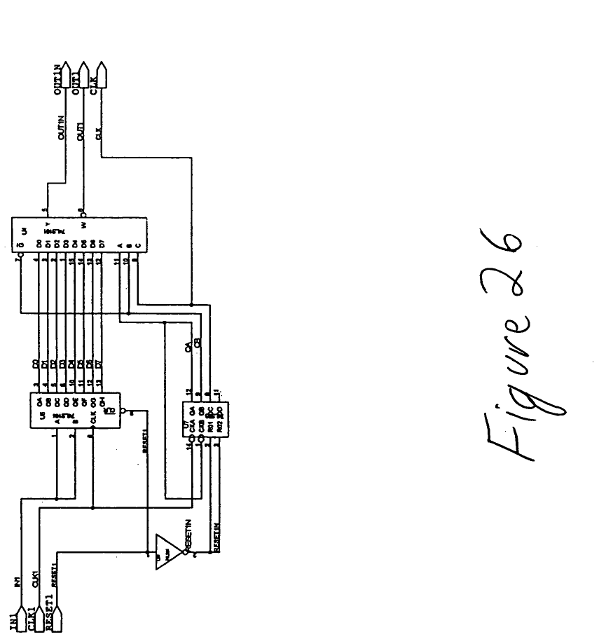

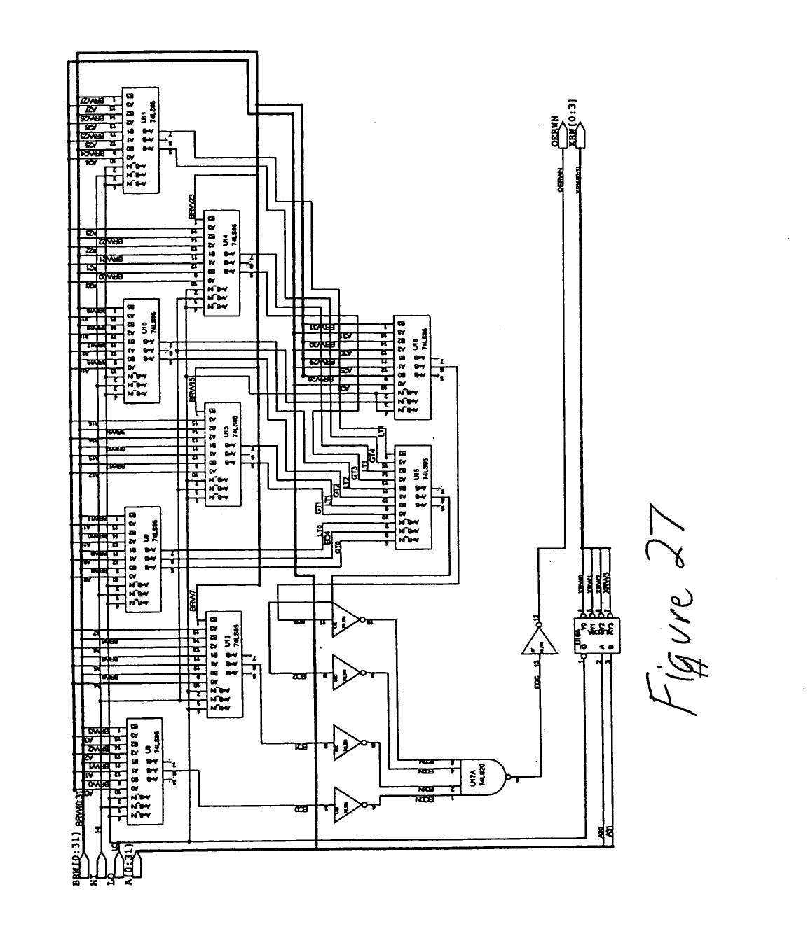

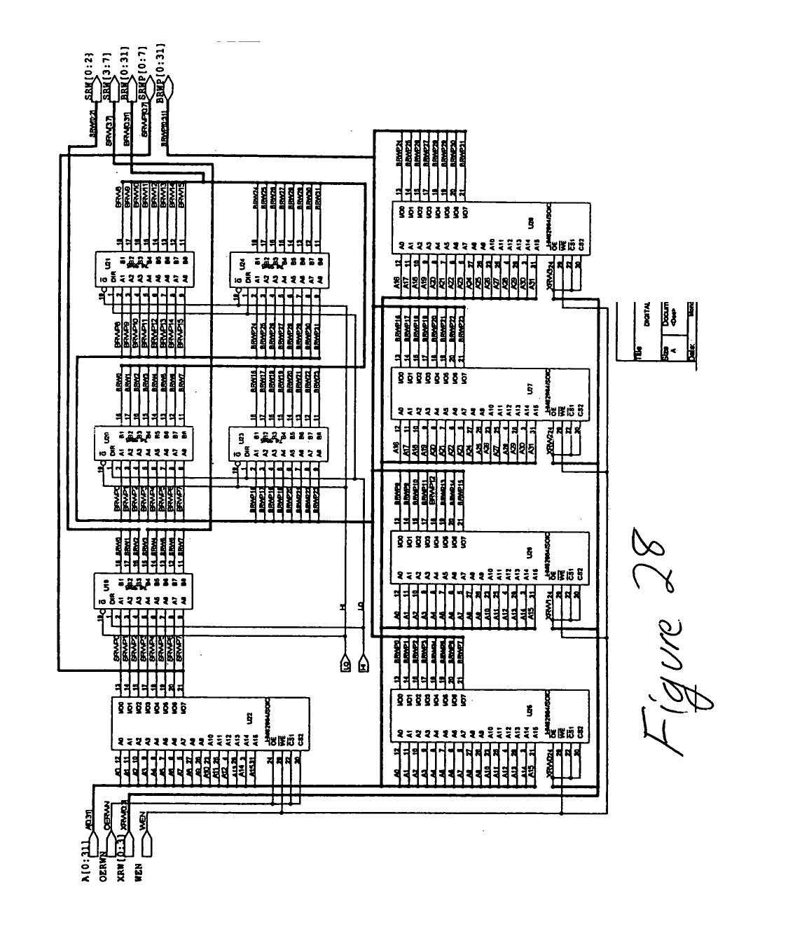

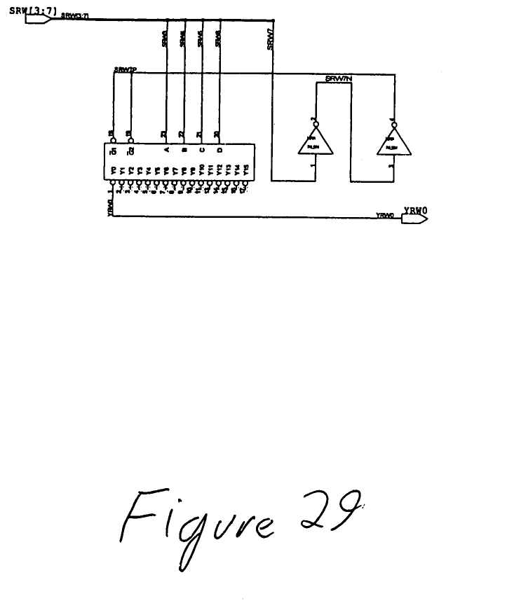

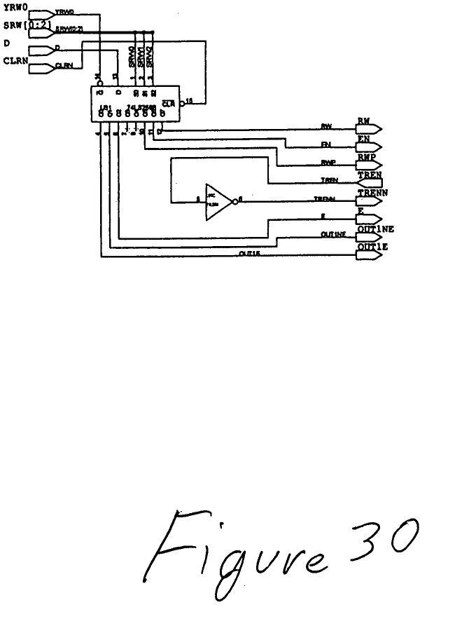

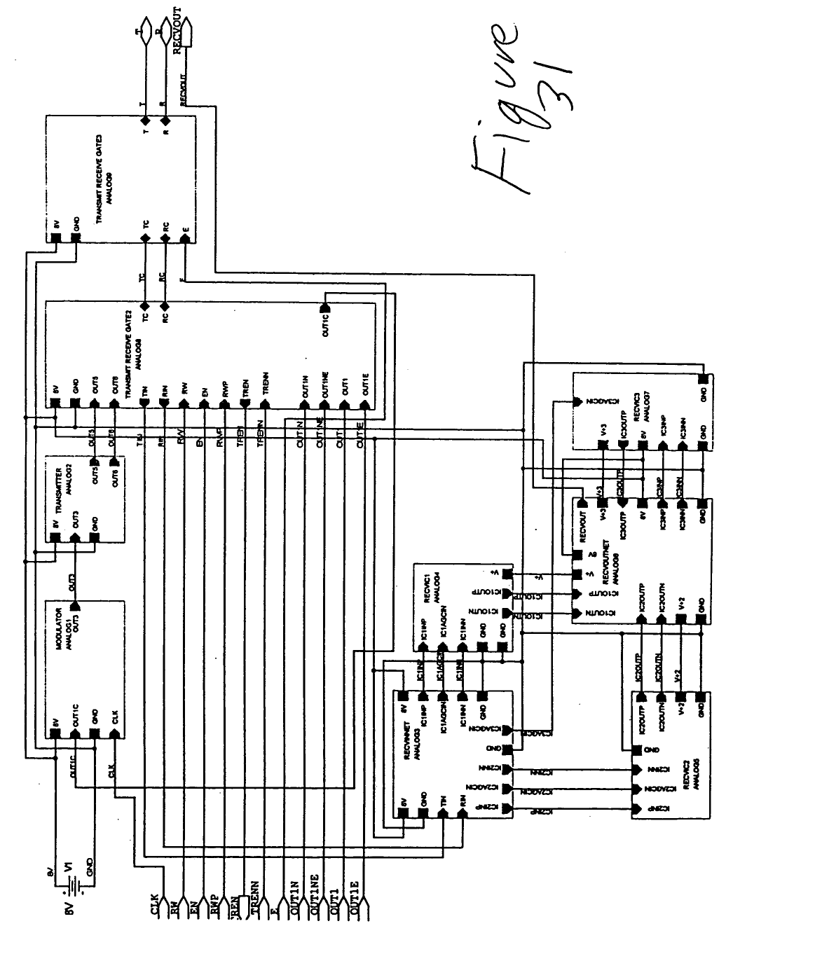

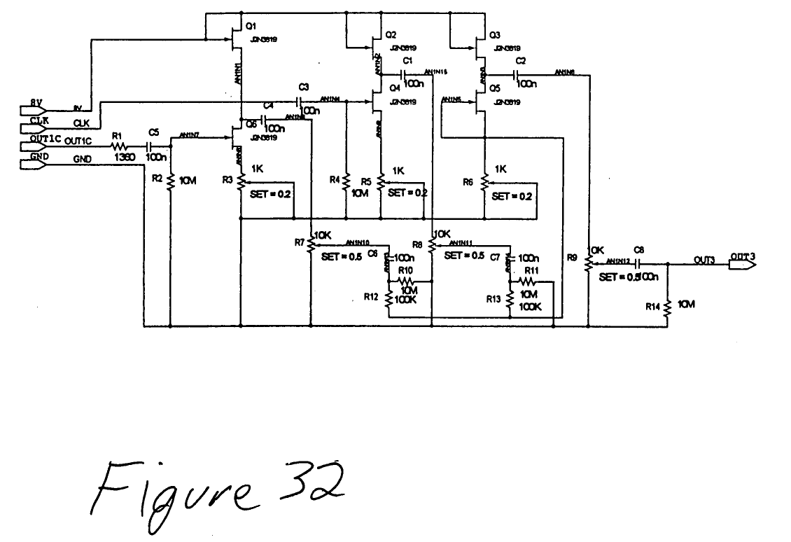

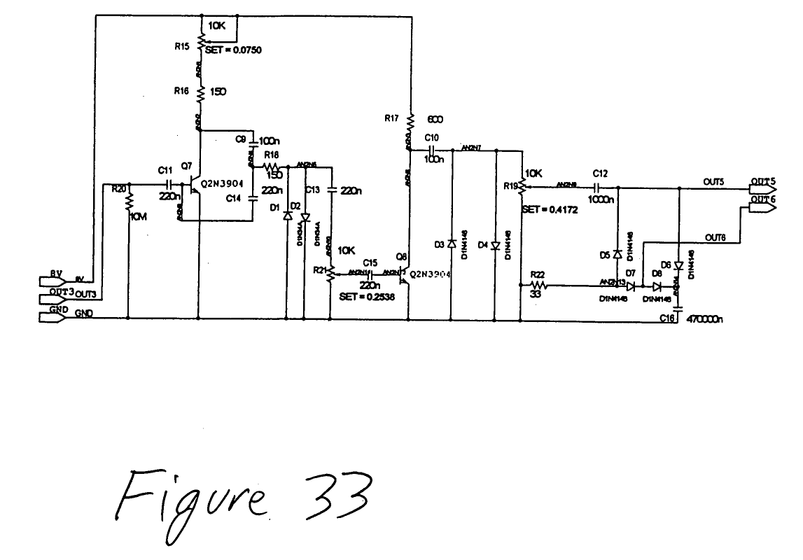

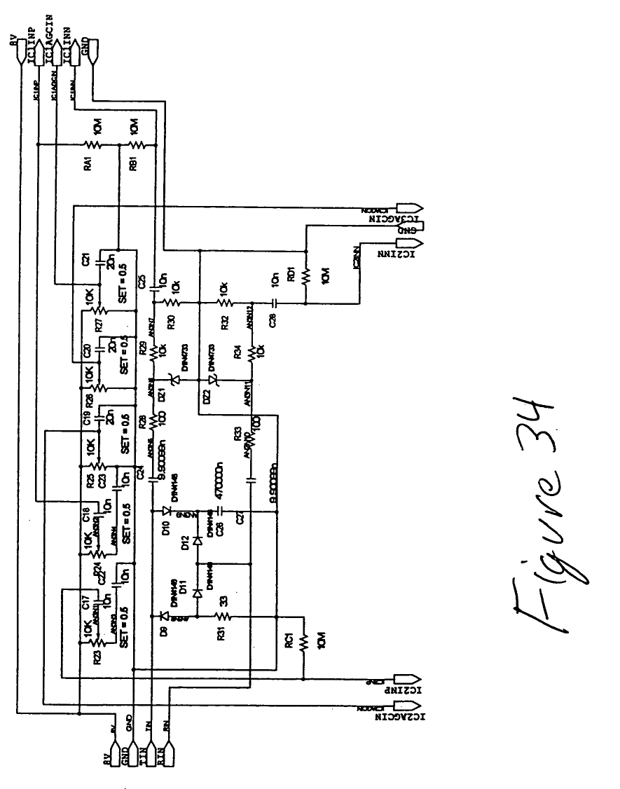

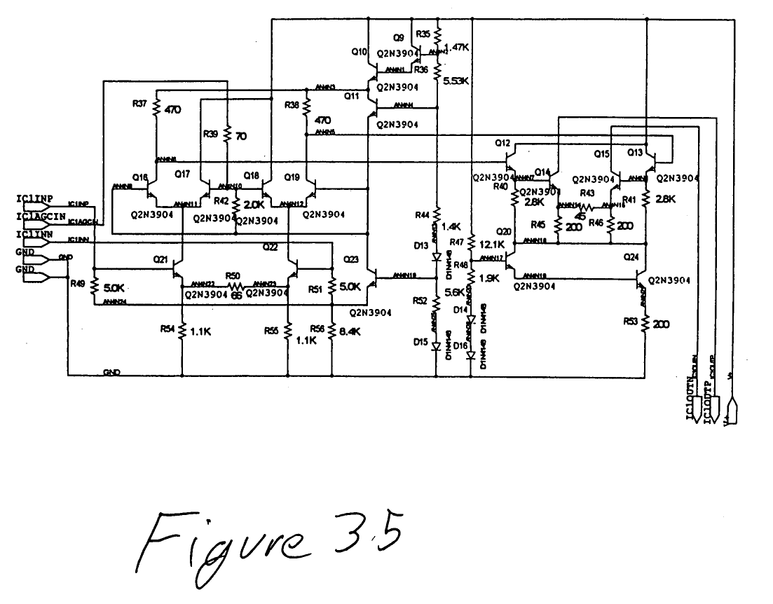

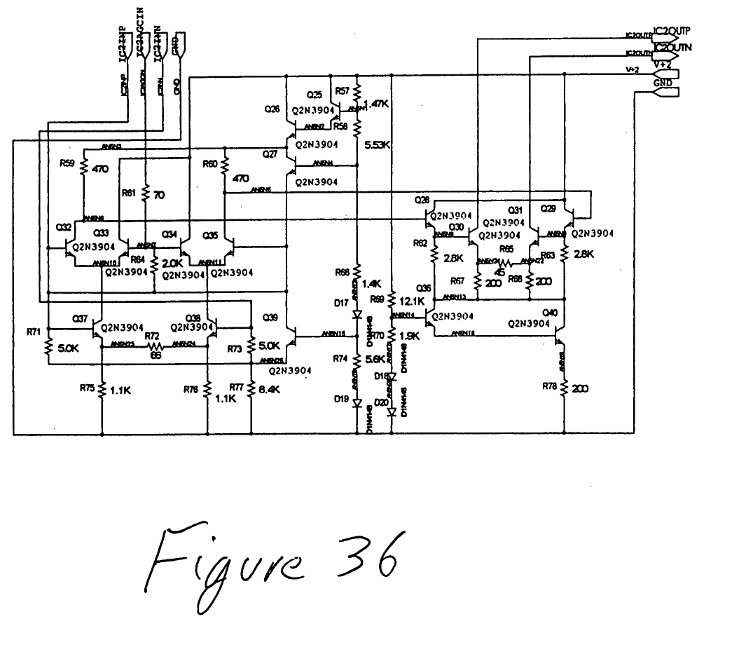

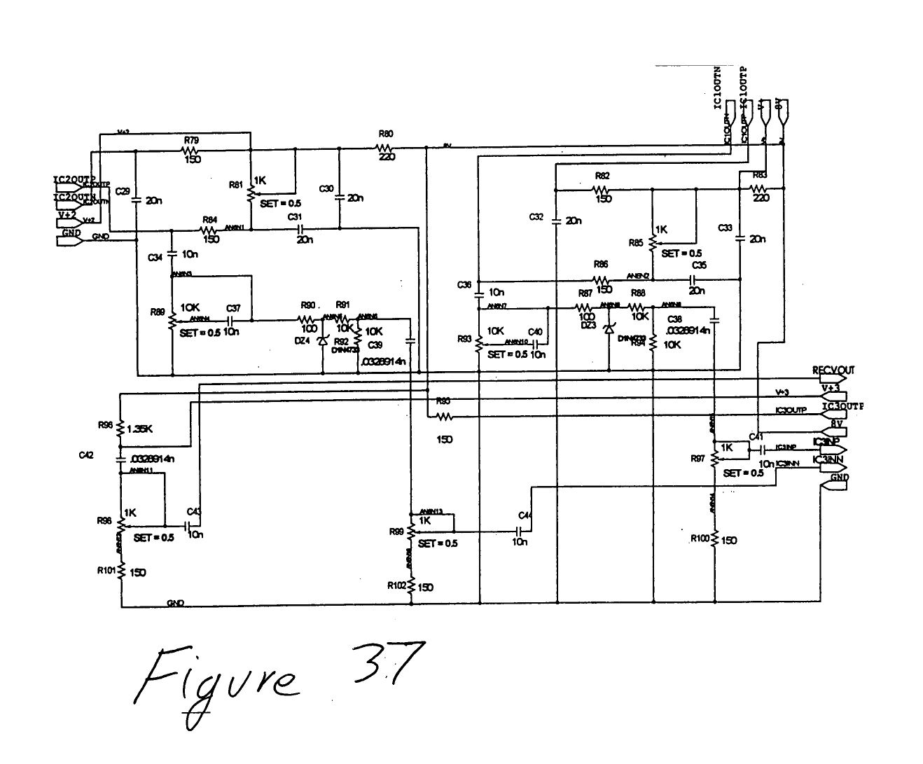

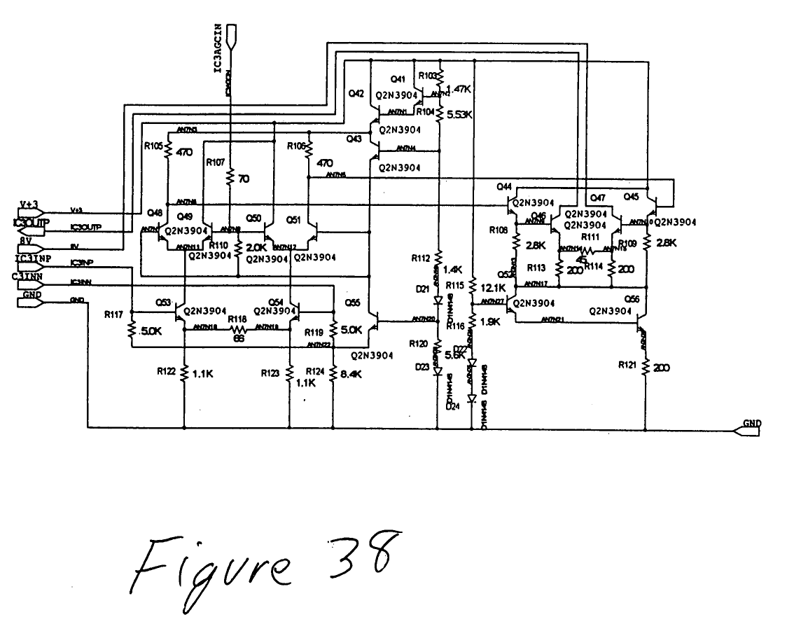

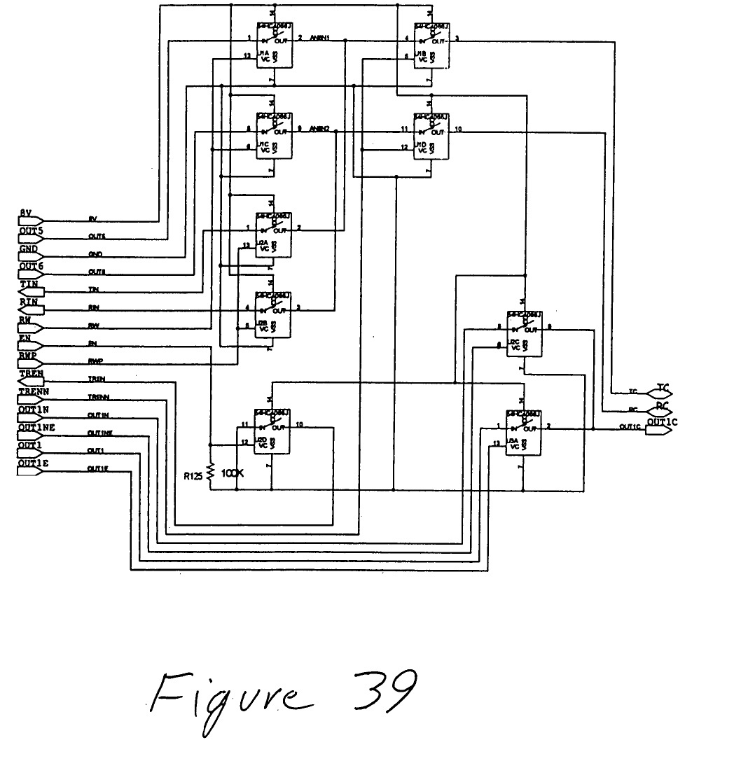

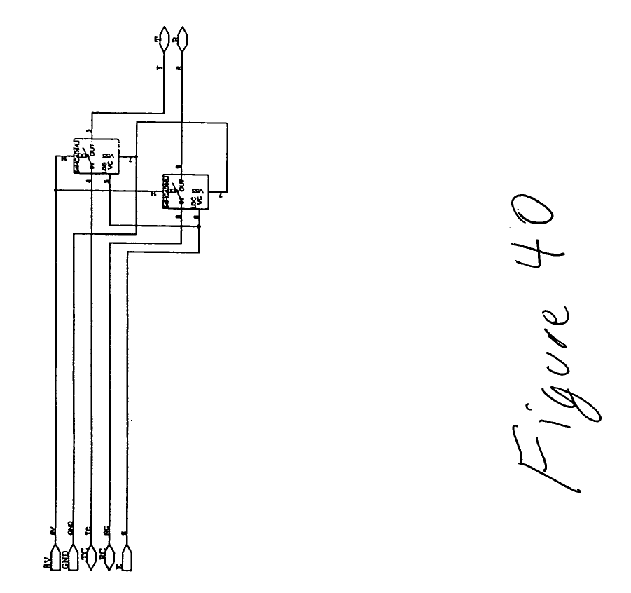

In an embodiment, depicted in FIGS. 23-40, a virtual direct connect system is provided for very low power optimum bandwidth utilization of a communication medium due to increasing demand for bandwidth. Preferably, the virtual direct connect system (“the system”) is a signal transmission, reception, and processing technology that is the core technology within virtual direct connect transceivers. The virtual direct connect system architecture is a transceiver technology which, when connected transceiver to transceiver by a communication medium, communicates in serial from Signal Transmit (Tip) to Signal Receive and Return Transmit (Ring) to Return Receive rather than using the conventional parallel prior art.

An optimum method in achieving the above objectives is that the system transmits impulses of AC current by varying impedances. Operationally, it appears that the transceivers are virtually connected directly together as long as the units are not factory set for very different medium impedance characteristics.- Preferably, the transceivers are factor set according to basic medium characteristics.

In an embodiment, the phrase factory set means the systems are preset at the manufacturer for a particular range of variation in the longitudinal impedance or resistance of a given communication medium. For example, for the majority of 24 or 26 gauge telephone lines, the transceiver is preset at the factory to operate within a range of 500 to 3K ohms. Preferably, this is done at the transmitter and receiver side.

Conventionally, systems make changes in transmission power levels and/or data transmission due to electrical variations in the communication medium. The virtual direct connect system's analog circuitry allows the electrical variations of the medium to change the system characteristics greater than the characteristics of the data transmission allowing for greater and more accurate throughput simultaneous to real time processing. In an embodiment, the virtual direct connect system provides constant compensation during the presence of data and/or electrical variations and distortions on the medium.

One component in achieving this is the automatic precision impedance measuring circuitry or “APIM” designed into each transceiver. In one embodiment, the APIM is similar to a real time impedance reactive bridge. In effect, a phone line is a bridge. Therefore, the virtual direct connect transciever has an intelligent bridge front end on each side of the line which individually responds in real time to electrical variations and imbalances of the transmission medium.

Conventionally, systems transmit voltage which is measured and/or processed in parallel across the signal and return (Tip & Ring) sides of the line to determine data. In an embodiment, the virtual direct connect system is a serial transmission system which transmits impulses of AC current and uses virtual grounds rather than a return line. This provides for parallel processing. For example, the transceivers transmit two individual signals, one on the signal side and one on the return side of the transmission medium and parallel processes the ratios of the signals.

In an embodiment, the virtual direct connect system is a serial transmission parallel ratio processing communication system. Typically, when one transmits current across the signal and return sides of the line, there is a loss in the ability to control and keep a constant voltage because one must vary voltage in order to get current changes across the line. The virtual direct connect system transmits AC current by keeping a constant voltage drop over the line (i.e., signal transmit to signal receive and return transmit to return receive).

Conventional systems may be transmitting voltages along the line as a current, but they receive a voltage metallically across the line (i.e., tip to ring). Voltage wise, if two separate signals are transmitted (i.e., one signal on tip and one signal on ring), one signal will add or subtract to or from the other signal.

Aside from performing high speed (real time analog) impedance variations according to the characteristics and electrical variations of the transmission medium, in an embodiment, virtual direct connect is doing these high speed impedance variations to generate impulses of AC current according to the bit stream.

It is recognized that there are only two choices, one can vary voltage, or one can vary impedance. If voltage is varied, then impedance must be kept constant which is difficult to do because of characteristics and electrical variations in the line such as the frequencies being transmitted, ground bounce, and noise from voltage variations. All of which make it difficult to maintain a constant voltage.

Such as virtual direct connect, if impedances are varied and a contant voltage drop is kept (tip to tip and/or ring to ring) then it is easier to transmit, maintain, and control impulses of current.

Turning to FIGS. 41-42, schematic block diagrams are depicted of correction systems in accordance with the present invention. In an embodiment, H_{y}(x) is roughly the amount of additional information that must be supplied per second at the receiving point to correct the received message. For instance, in long sequences of received message M′ and corresponding original message M, there will be logarithmically TH_{y}(x) of the M's which could reasonably have produced each M′. Thus, there are TH_{y}(x) binary digits to send each T seconds. This can be done with ε frequency of errors on a channel of capacity H_{y}(x).

Moreover, by noting that, for any discrete chance variables x, y, z that H_{y}(x,z)≧H_{y}(x). The left-hand side can be expanded to give

H_{y}(z)+H_{yz}(x)≧H_{y}(x)

H_{yz}(x)≧H_{y}(x)−H_{y}(z)≧H_{y}(x)−H(z)

If x is identified as the output of the source, y as the received signal, and z as the signal sent over the correction channel, then the right-hand side is the equivocation less the rate of transmission over the correction channel. If the capacity of this channel is less than the equivocation the right-hand side will be greater than zero and H_{yz}(x)>0. But this is the uncertainty of what was sent, knowing both the received signal and the correction signal. If this is greater than zero the frequency of errors cannot be arbitrary small.

Example:

Suppose the errors occur at random in a sequence of binary digits: probability p that a digit is wrong and q=1−p that it is right. These errors can be corrected if their position is known. Thus, the correction channel need only send information as to these positions. This amounts to transmitting from a source which produces binary digits with probability p for 1 (incorrect) and q for 0 (correct). This requires a channel of capacity

−[p*log p+q*log q]

which is the equivocation of the original system.

The rate of transmission R can be written in two other forms due to the identities noted above. In particular,

R=H(x)−H_{y}(x)

R=H(y)−Hₓ(y)

R=H(x)+H(y)−H(x,y).

As stated previously, the virtual direct connect system provides for maximum exploitation of communication infrastructures such as, for example, those utilizing copper or other metallic transmission leads.

Conventionally, copper communication mediums are built based on the universal electronic principle of signal and return (or tip and ring). Together, signal and return has provided for the ability to transport analog and digital information by measuring and/or determining a voltage differential between the two. This is referred to as the metallic or parallel voltage differential in which it is common to match impedance between signal and return. This metric suffers many limitations, not the least of which is severe attenuation of this voltage differential over long transmission lines.

In an embodiment, the virtual direct connect system decodes data by determining a current differential between two independent measurement resultants as opposed to using a conventional method of measuring a voltage differential between the tip and ring sides of a line. Determining a current differential can be achieved in various ways depending on the virtual direct connect technology application. One technique isolates the tip and ring sides of the signal line from each other, creating a virtual break in the loop. Another technique provides an independent virtual ground to each (tip and ring) side of the line. In any case, the system has no direct return as shown in FIG. 43.

Since the virtual direct connect system does not need a loop to complete the circuit, data decodes is enabled through a series current measurement that in turn enables single conductor data transport. This eliminates any need for knowing the voltage potential between tip and ring at the receiver.

In an embodiment, a virtual direct connect transmitter transmits bits represented as current pulses. The waveform and bits are preferably shaped and controlled in various ways for optimum throughput as described below. In an embodiment, varying impedance and maintaining a constant voltage of about 1 volt generates the bits (impulses of current).

Since bridged taps are a shunt to the line (voltage divider), the virtual direct connect transmitter current impulses are not attenuated like conventional signals. Thus lower power transmissions are enabled.

As stated above, the system preferably operates on independent conductor series current differentials from transmitter to receiver (tip transmit to tip receiver & ring transmit to ring receive). As such, the system provides connected advantages.

As noted above, the system generates bits by impedance variations. Also, a larger impedance is provided at the receiver. With the system connected, it is shown that with this large impedance, virtual direct connect intentionally creates a series (longitudinal) imbalances as shown in FIG. 44.

Turning to FIG. 45, in an embodiment, the counterweight effect is part of the Automatic Precision Impedance Measuring and Compensation Circuitry (“APIMC”) used to counteract the attenuation effects longer transmission lines impose on transmitted signals. This large impedance imbalance makes the line appear to be a very small load on the signal due to the percentage of change of voltage across the impedances (I*R). This is preferably done independently on each conductor. An advantage is provided in low power transmission requirements.

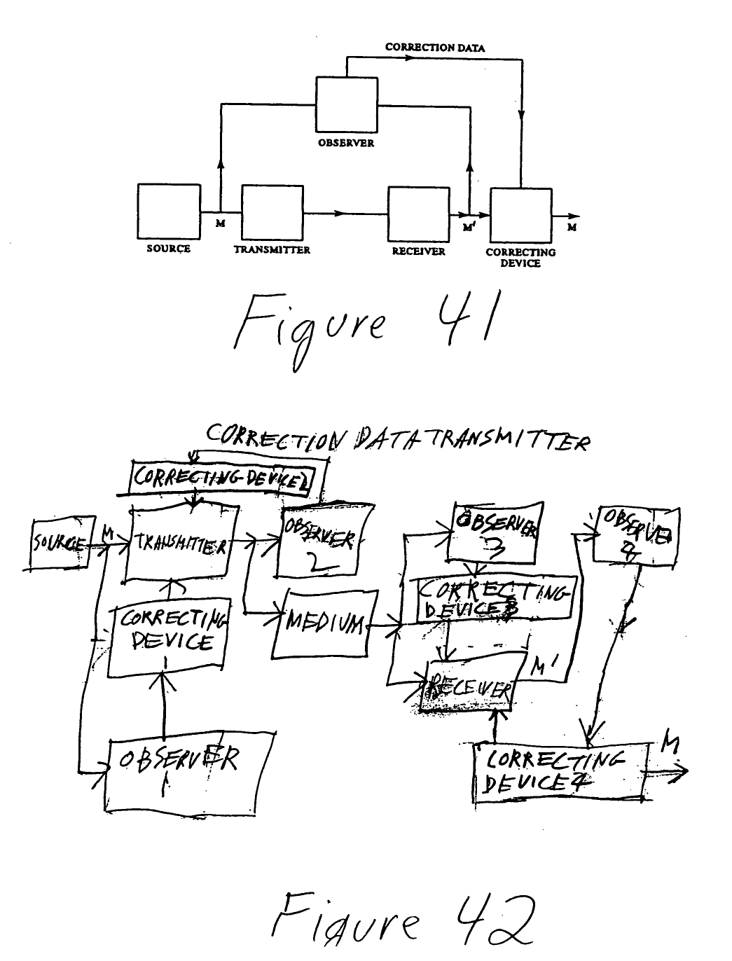

The difference between the counterweight effect (FIG. 44) and the APIMC as a whole is that the counterweight is a fixed impedance creating an imbalance and the APIMC uses variable impedances to keep balance within a range. This compensates for any negative effects caused by the line. This is additionally done independently on each conductor. Turning to FIG. 46, a total series impedance of a connected system on one conductor (i.e., Tip) is depicted. In this example, the total series impedance is 2.4 K prior to any changes occurring on the medium. In FIG. 46, additional impedances that create the actual total impedance are not shown for simplicity.

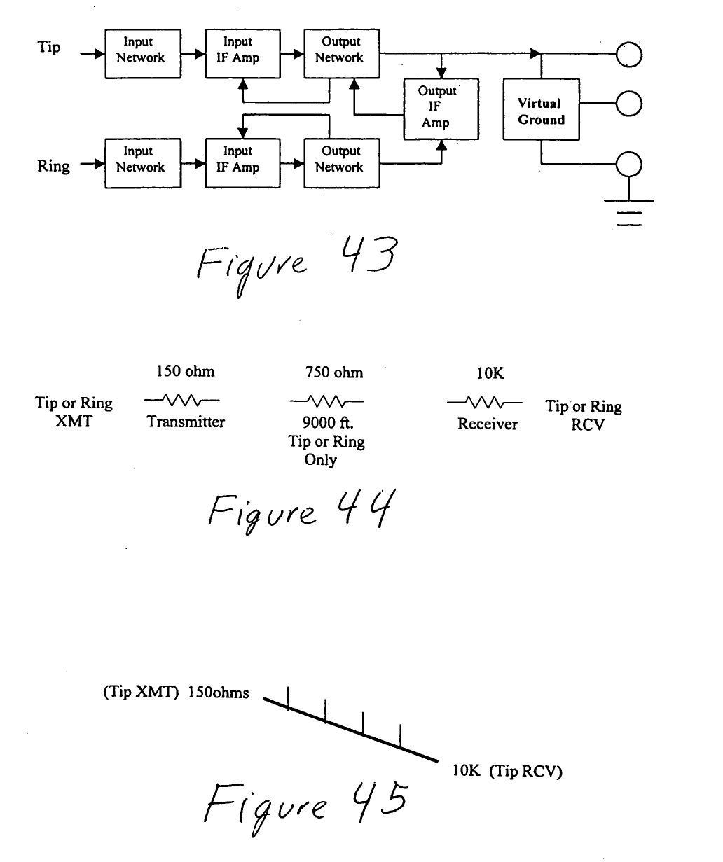

Turning to FIG. 47, an example is provided of how the APIMC circuitry reacts to changes in the transmission medium. The medium's impedance drops down to 250 ohms and the total series impedance is reestablished to 2.4K by one or both ends of the virtual direct connect system. Additionally, this is done independently on each individual conductor.

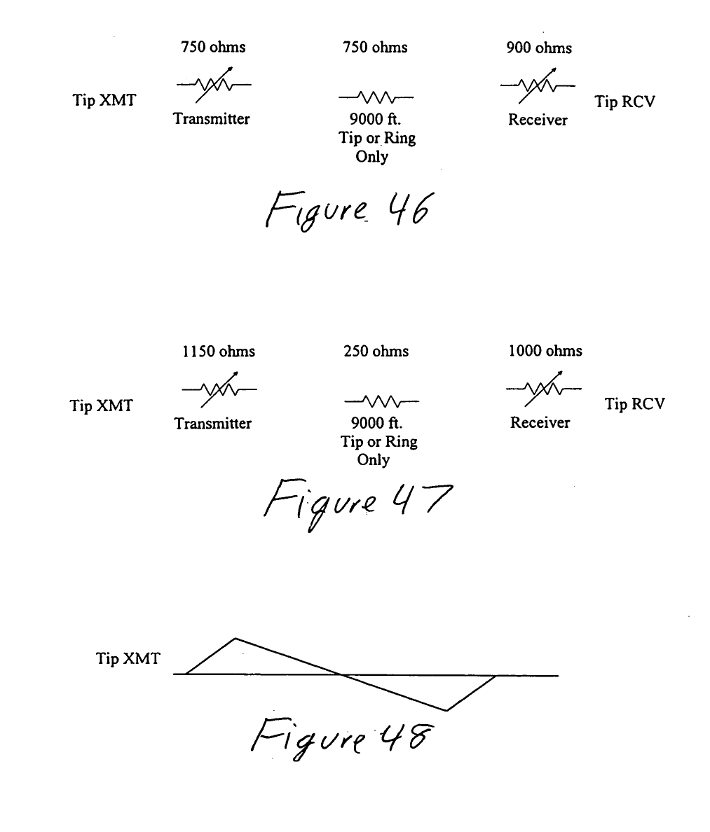

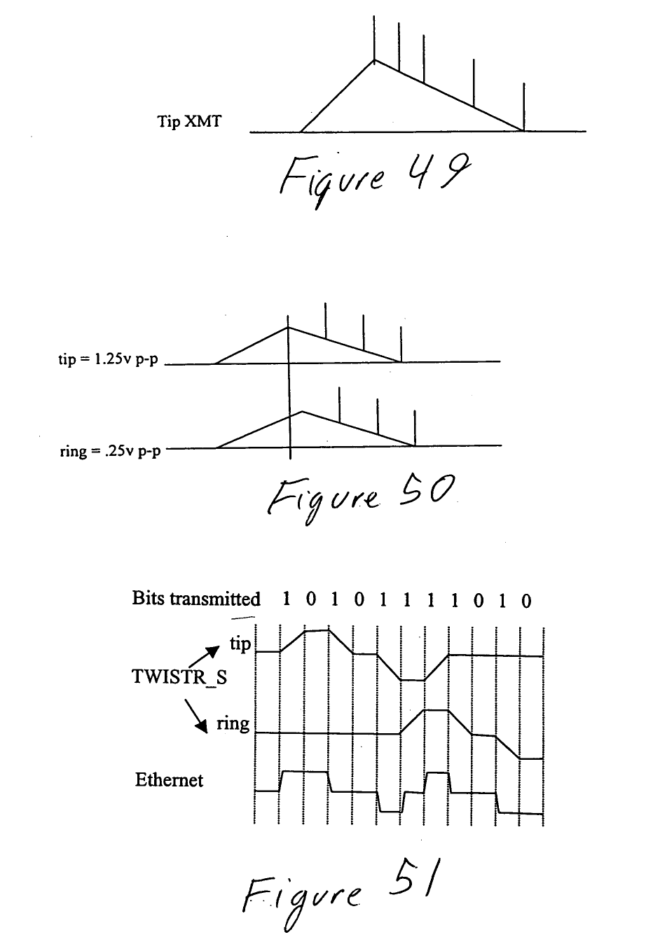

Turning to FIG. 48, in a embodiment a waveform is transmitted over tip that has a slope controlled asymmetric shape. Moreover, FIG. 49 depicts the wave of FIG. 48 encoded with impulses of current representing bits. The bits ride on the leading edge of the waveform and the trailing edge can be used as quiet space. These bits are not threshold dependent.

However, multiple bit representation can be achieved per bit by using thresholds. Additionally, the negative slope can be used for symmetric or inverted throughput increases.

This slope controlled asymmetric waveform is duplicated (i.e., shadowed) at different amplitudes and shifted prior to transmission over their independent lines. FIG. 50 depicts how the bits and entire waveform are sent in duplicate. The signal and its shadow are sent over their respective conductors. All of these factors provide for real time ratio processing and error correction at the receiver.

The virtual direct connect system enables a service provided to actually convert each individual connection of a tip and ring wire into two connections without laying cable. This split utilization of a single twisted-pair provides flexibility and scalability to the service provides for keeping up with the growth of Internet appliances and other home networking and access devices. This may be beneficial in various cases and still provide more throughput than many conventional systems, however, this transformation in how the loop is used to communicate creates a paradigm shift in the overall approach to data transport and readies service providers for the bandwidth demands they face today and in the future.

By communicating with bits represented as impulses of current, the system virtually resides within its own domain. The system adapts to the ever changing environment of a communication medium by avoiding and compensating for the significant effects causes by bridged taps and other attenuation factors. Furthermore, physically enabling the unique method of time shifted shadow (parallel) modulation and ratio processing delivers more bandwidth, more accurately over greater distances at lower power than any voltage based transport technology developed to date.

In an embodiment in accordance with the present invention, current domain data transport (“CDDT”) applies energy to a transmit path using a current source. Further, two-wire independent signal transport (“TWISTR”) describes a methodology and encoding scheme whereby twisted pair, two wire normally used for a single channel of differential communication, are utilized as two independent signal paths. This effectively yields a minimum two-fold increase in data rates at any given distance.

In exploring the concept of signal flow, the analogy of water flowing though a river to the ocean is presented. In order for water to flow toward the ocean, there must be a continual supply of water. In this case, the evaporation of water and subsequent rain shower form the “return” that enables a river to flow endlessly.

If a person up river sets off an underwater dynamite charge, both surface (transverse) and sound (longitudinal) waves will travel in all directions from the disturbance point. These waves will travel in spite of any “return.” In fact, the river does not even need to be flowing for the waves to travel. The only thing required to conduct the waves is the medium of the water.

Wave propagation in all mediums is governed by the Helmholtz wave equation of which the unidirectional form is shown below:

$$\frac{{\partial }^{2} u}{\partial {t}^{2}} = {v}^{2} \frac{{\partial }^{2} u}{\partial {x}^{2}}$$

All traveling wave phenomena such as waves on a string, sound waves, water waves, and even Maxwell's plane wave equations satisfy the Helmholtz wave equation.

By inspecting the equation, or even Maxwell's equations, one of ordinary skill in the art will appreciate that they are “point” equations. This means that the propagation of wave energy along a continuum of conductible media only depends upon the conditions at a given point. In no way does this equation specify the requirement of a return path in order for waves to propagate. Light waves traveling through space do not need a return. Sound waves traveling through air do not need a return. Nor should electric waves need a return.

A return only becomes critical when there is not sufficient medium present to sustain a wave. This occurs with very long wavelengths. Generally, if the length of the pathway that conducts the wave is shorter than the wavelength of the signal, then a return is required to adequately pass the entire wave. If you view DC as a wave with infinite wavelength, then a return is necessary.

In an embodiment the TWISTR line-coding scheme can be compared to Ethernet encoding as depicted in FIG. 51. In the FIGURE, the ‘S’ stands for SYMETRIC. Using the line-coding scheme, if a “1” needs to be sent, then the active line slopes to the next level. Activity alternates between the lines to reduce the switching rate on a line thereby extending the range of transmission. Transmission begins with the first transition on the TIP line. Transitions on a line will follow the sequence slope up, stay, slope down, stay, slope down, stay and slope up.

The advantage of TWISTR_S over Ethernet is apparent. By using a gentle slope to send a bit, the harmonics entering a lossy transmission are effectively “soften.” Moreover, by reducing the high frequency harmonics associated with fast ring edges, the brick-wall effects of line inductance are reduced enabling the signal to transmit over a longer distance. Another benefit of slow rising edges is the reduction of electromagnetic interference generated. This reduction of interference is further enhanced by the used of Current Domain techniques described later herein.

Preferably, each cycle of a TWISTR_S line (tip or ring) transmits 4 bits of information. This is the identical channel capacity as a 16 QAM. Since two TWISTR_S signals (tip and ring) are used in parallel, this gives 8 bits of information per hertz. This is equivalent to the amount of information contained in a 256 QAM encoding; according to the 1999 xDSL report, the 64 QAM is the highest channel capacity in use and is limited to 4000 feet. The higher QAM architectures have smaller inter-symbol margins and are therefore more susceptible to noise; consequently, they have shorter transmission distances. The TWISTR_S does not suffer from tight symbol margins. Logically, the industry standard 6000-foot limit for 1.544 megahertz fundamentals (we use 1.5625 Mhz) will yield a TWISTR_S symbol rate of 12.5 Megabits/second at 6000 feet (8 bits per hertz). In an embodiment, transmission of the TWISTR_S is through a pair of digitally controlled current sources

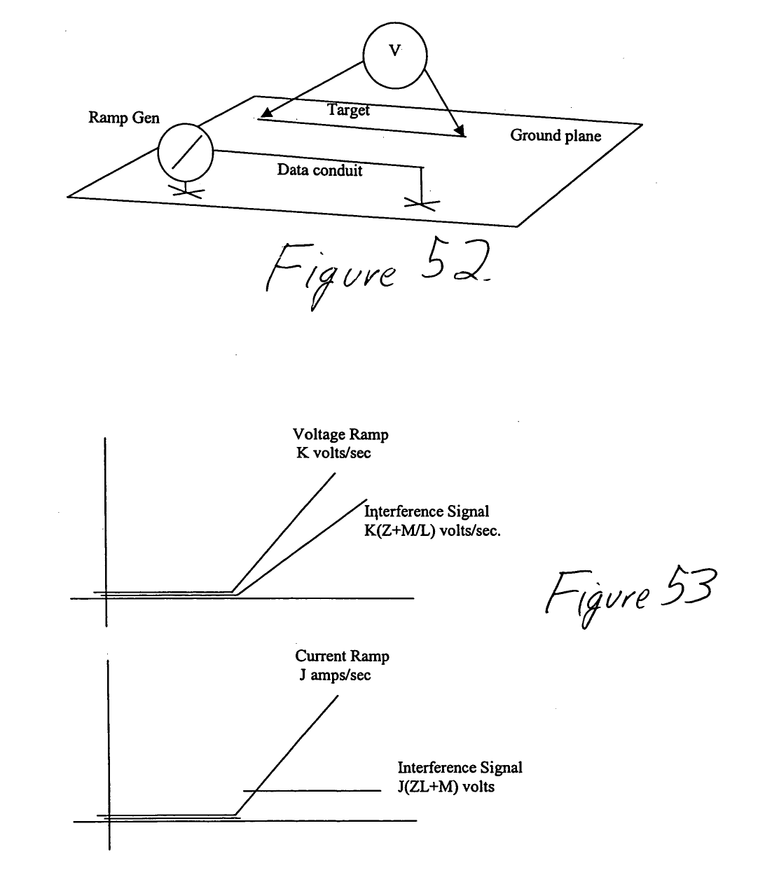

The TWISTR data channel driven by a current source and a voltage source can be mathematic model wherein it is shown that the CDDT methodology produces less interference. For the comparison, two parallel finite length signal conduits are considered as shown in FIG. 52. The length of these lines is sufficiently short as not to be considered transmission lines. The first is the data channels whose emissions are to be measured. The second is the target where the emissions are measured. Accordingly, the following variables are introduced: M=the mutual inductance between the two conduits; L=the series inductance of a conduit as measured from the transmitter; Cm=the capacitive coupling between the two conduits; C=the intrinsic capacitance of either conduit; K=slope of voltage ramp in volts/sec; J=slope of current ramp in Amp/sec. In addition, the following equations are introduced:

1 emf(S)=LS(S)—back emf generated from current change through either conduit

2 emf(S)=MS(S)—emf coupled to target due to current change in data conduit

$$3 v ( S ) = \frac{( Cm + C ) v ( S )}{C} = Zv ( S )$$

The voltage induced in the target from a change in voltage of the source.

$$4 v ( s ) = \frac{K}{{S}^{2}}$$

Voltage Ramp

$$5 i ( S ) = \frac{J}{{S}^{2}}$$

Current Ramp

Preferably, the energy coupled to the target due to inductive coupling and capacitive coupling between the data conduit and the target is calculated, then the results are collected for comparison.

Inductive coupling:

For the Voltage Ramp:

1) The current through the data conduit is found be equating equations 1 and 4 which yields

$$\frac{K}{{S}^{2}} = L Si ( S ) .$$

Solving for

$$I ( s ) = i ( S ) = \frac{K}{L {S}^{3}}$$

2) The emf coupled to the target is found by substituting the above into equation 2 which yields

$$emf ( S ) = \frac{M K}{L {S}^{2}}$$

When applying a voltage ramp to the data conduit, a ramp is induced in the target.

For the Current Ramp:

1) The emf induced in the target is simply equation 5 substituted into equation 2 which yields:

$$emf ( S ) = \frac{M J}{ S} .$$

The above result is a step response.

Capacitive coupling:

For the Voltage Ramp:

To find the energy coupled we simply substitute equation 4 into equation 3.

$$v ( S ) = \frac{K Z}{{S}^{2}}$$

The above is a voltage ramp

For the current ramp:

To find the emf from the current ramp we substitute 5 into 1 to determine the voltage which yields:

$$emf ( S ) = \frac{L J}{S} i ( S )$$

Then substitute the above into 3.

$$v ( S ) = \frac{JLZ}{S}$$

The above is a step.

Comparison:

$${emf}_{V} ( S ) = \frac{K}{{S}^{2}} ( Z + \frac{M}{L} )$$

$${emf}_{I} ( S ) = \frac{J}{S} ( LZ + M )$$

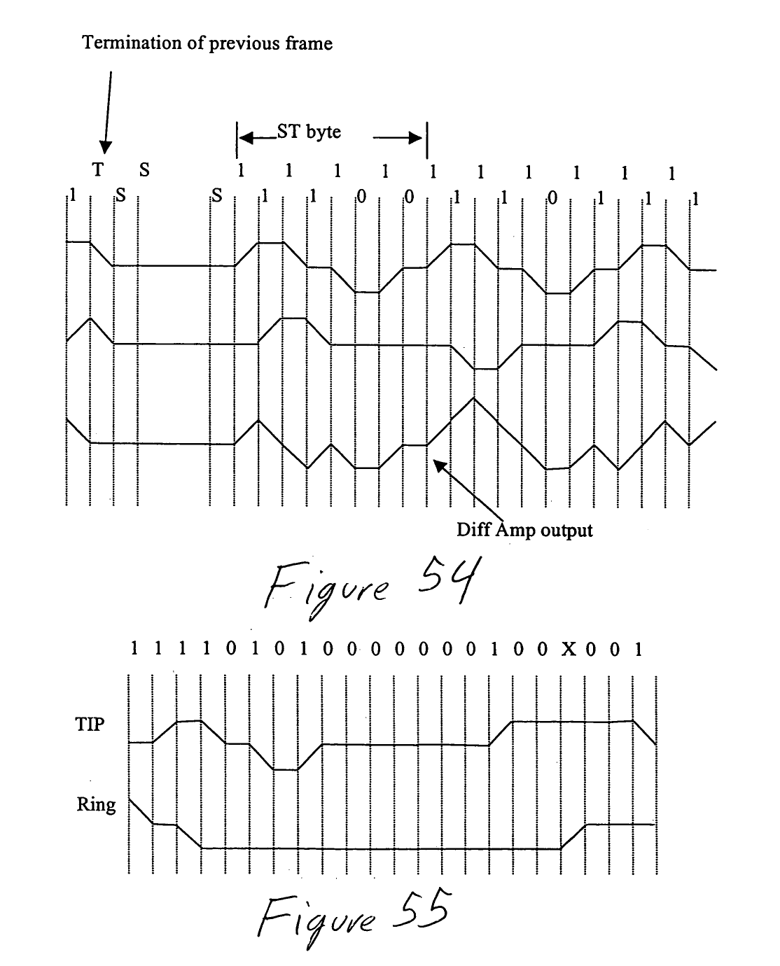

The above equations, graphed in FIG. 53, show that emissions from a current ramp are different from a voltage ramp. The interference from a voltage ramp is a ramp. The interference from a current ramp is a step function. If the interference occurs between tip and ring of the same pair, then the step interference will cause the least harm. This is because while one side of the pair is sloping, the other side is holding steady. A small step applied to the steady side will not hinder signal detection much.

For common mode interference (interference from other TWISTR circuits and other outside sources) a differential circuit with good CMRR and judicious oversampling by the FPGA can be utilized. Since bit information in TWISTR_S overlaps, the signal preferably contains built in redundancy to allow simple error correction schemes.

When performing “Ping-Pong” type communication, the devices at each side of the communication line alternately send then listen. When the design uses digitally controlled current sources as line drivers, then switching between listen mode and transmit mode can easily be accomplished by one having ordinary skill in the art. For transmit (send), the digital inputs are set to reflect the current to be transmitted. For listen mode, the digital inputs are set to zero current. Because a current source is an open circuit by definition, there is no need to disconnect the drivers from the line.

In an embodiment, a differential circuit can be used for eliminating interference. FIG. 54 provides a diagram depicting the output of a differential circuit with the input waveforms given.

Preferably, the differential amplifier is constructed to subtract ring from tip. In so doing, the common mode interference is eliminated. Because the output of the differential amp is unconstrained by the switching limitations of the line, it is able to reconstruct a signal with all the originally transmitted information intact and extractable by digital signal processing means.

Because the two lines can be aggregated with a differential amplifier to yield an output with the original data intact, a new encoding methodology has evolved to capitalize on this phenomenon. The new encoding methodology is called TWISTR_A. TWISTR_A, which combines zero compression and other techniques, and yields a 2× increase in performance over TWISTR_S.

In observing the differential amplifier output, it should be noticed that there are many sharp points. These sharp points are easy to identify and clearly identify bit boundaries. Preferably, a FPGA performs DPLL synchronization on these detected edges. The sampling points for slope detection will shift ½ bit period from the detected bit edges. To eliminate noise and increase sensitivity, oversampling is utilized.

Referring to FIG. 54 the signal only transitions when there are ONEs to send. This means that transmitting data containing an excessive number of zeros may cause either/both outputs to maintain a constant level. This could cause a problem if the signal must pass through AC coupled circuits or across traditional twisted pair magnetics used in POTS.

In order to ensure that the TWISTR signal maintains a minimum rate of transition a 1 is inserted into the bit-stream for every 7 zeros detected in a row on TIP or RING. FIG. 55 provides a chart depicting a one- insertion (X) on the RING.

Ones Insertion preferably occurs even if the lines are at zero potential. These transitions enable the DPLL to maintain synchronization. These transitions also prevent the receiver from falsely detecting silence (described in the next section) and dropping the current packet.

In an embodiment, the One Insertion Counters (OIC) start counting on the first bit of the ST byte. For an OIC count of 7, the line is low for about 16 bit periods. This means that the lowest switching rate period is 32 bit cycles. The lowest selectable transmission rate for the system is 1.5625 Mb/s. At this rate, the lowest switching harmonic is 1562500/32=49 Khz. This is well above the audio band of POTS.

One of the founding principles of Shannon's paper is as follows: “ . . . two identical channels [have] twice the capacity of one for transmitting information.” Since each wire of a twisted pair is an independent signal path, then a starting claim or TWISTR_S is two times the bandwidth of a twisted pair used for standard differential signaling.

Twisted pair lines are typically lossy. This means that terminating a line with its characteristic impedance may not be as simple as terminating the line with a resistor. The characteristic impedance of a lossy line is typically reactive. A reactive line will ultimately produce reflections if terminated by a real impedance.

Receive side reflections can be canceled by the Reflection cancellation algorithms as described above; however, this would not allow optimization of the line for full duplex operation (where both sides transmit at the same time).

There are a number of unique methods for providing termination to remove the energy from the end of the line without reflection. These methods can include active and passive.

In an embodiment, all information that passes between near and far side is divided into “chunks” of 48 to 64 bytes each. Each “chunk” is encapsulated in a frame. This process is called packetization. The frame enables the system to determine what the type of information is (data or management/ control) being sent. The frame provides a simple error check to determine system quality to enable the system to take measures to improve reliability.

The system encapsulates and sends OAM messages (Operation and Maintenance) as part of the normal chatter of operation. These are NOT ATM OAM cells. The OAM messages are specific to this system and are only a few bytes (Not an entire 53 byte CELL as with ATM).

The first byte of every frame is called the ST byte (SYNC/TYPE) it performs two functions. The first function is to provide a start reference for the far side DPLL (Digital Phased locked loop). The second function is to inform the far side what type of frame is being sent. In an embodiment, there are four frames types in this first release of the system: 1) CELL data transport ST=11111010; 2) BULK data transport ST=11110101; 3) OAM management message ST=11111111; and 4) OAM termination message ST=11110000.

Preferably, the Bytes in the system are transmitted MSB first. As one having ordinary skill in the art will notice, the most significant bits of each ST byte contain the same pattern. This pattern is the sync pattern that provides a clean trapezoid on TIP for the far side to synchronize to. The next 4 bits provide the frame type indicator.

In an embodiment, software performs a simple checksum on the data that is the inverted sum of the bytes after the ST byte up to, but not including, the check sum byte. However, other schemes can be used for error checking.

FIG. 56 depicts a cell data transport frame. Cell data transport is the preferred transport method because it contains inherent information (such as cell size) that does not need to be enclosed in the transport.

Preferably, cell size is an FPGA compile time constant and the cell size is optimized for ATM cell transport. The Frame information is removed before the data is dumped into an FIFO. Furthermore, the SOC flag is set on the first byte of the cell that enters the FIFO. Should a checksum error or the abrupt end of the cell be detected, the remainder of the cell is padded with zeros. The checksum error is logged as well as incomplete cells.

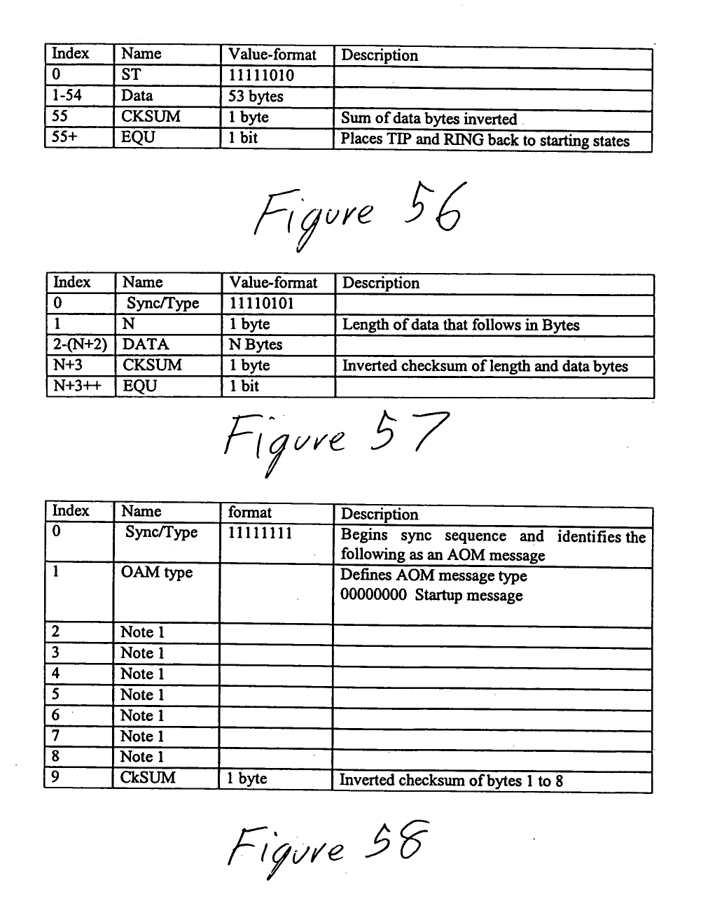

Turning to FIG. 57, bulk data transport frames are depicts for supporting various interfaces and test platforms if needed. Preferably, however, this frame is not supported if not needed.

Turning to FIG. 58, OAM management messages are depicted. The purpose of these messages is to allow the RISC processors to communicate to exchange operational information and control. There are many OM messages that fall into this frame type. One such application of these messages is to place the system into line check mode where the system performs an iterative process to compensate for line changes.

It should be noted that the fields shown in FIG. 58 depend upon the message being sent. All AOM messages are ten bytes long at this filing. Any unused field are considered reserved for future use.

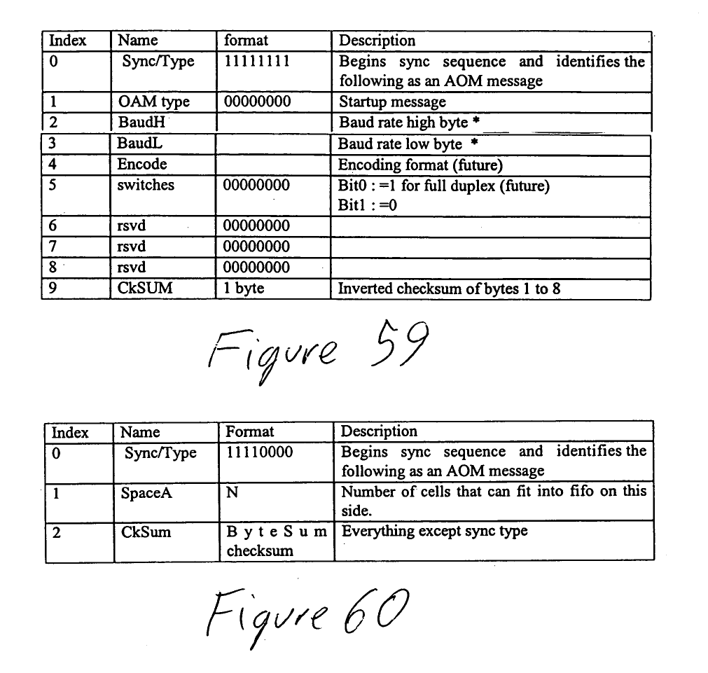

Turning to FIG. 59, an OAM startup message is depicted. The purpose of this message is to negotiate the startup between the master and slave. In FIG. 59, baud rate is in Kilobits per second. Although one embodiment can operate at operational speeds at or below 12.5 megabits per second, alternative embodiments of the system can have sampling at 100 megasamples per second. In FIG. 59, the set-able range is from 1 Kbps to 65 Mbits/sec; where 1111111111111111=65,536,000 bits per second.

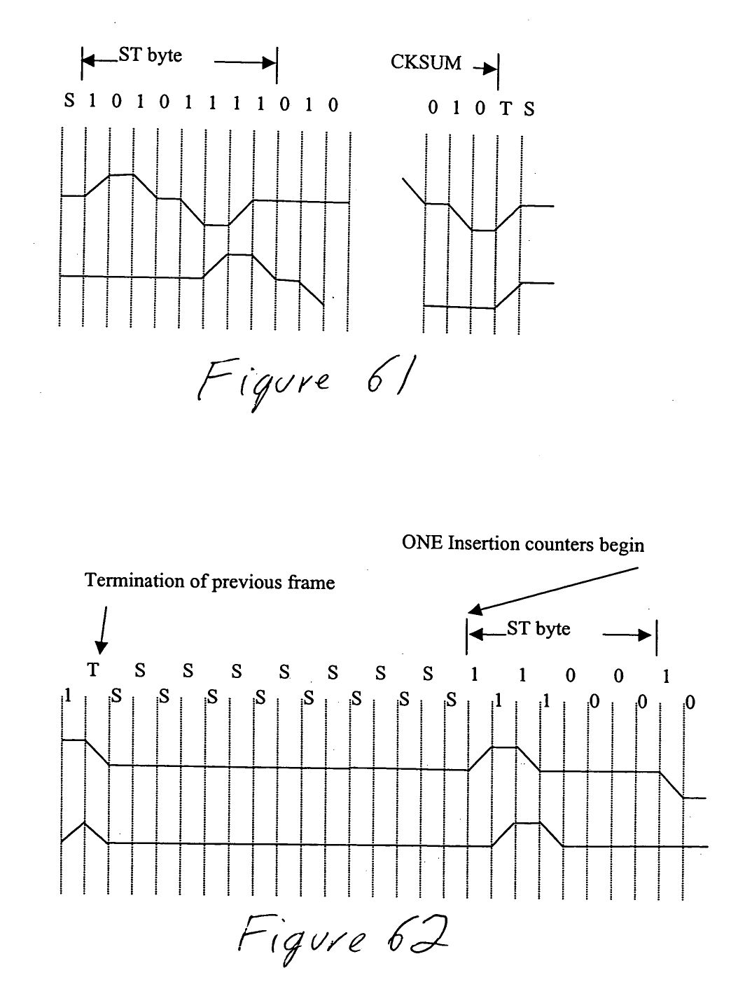

In FIG. 60, OAM termination messages are depicted that preferably serve two purposes. The first is to inform the far side that the current transmission session is complete and that it can start its transmission. It also serves as a “heartbeat” when there is no information to be sent, these messages are constantly sent back and forth to check the integrity of the link. The purpose of this message is the following: 1) To indicate that the session is complete; 2) To inform the other side how many cells in can receive (how much space is left in its receive FIFO); and 3) To operate as a heartbeat/line-check message in the absence of data to transmit. Preferably the OAM termination messages is automatically generated by FPGA.

The typical behavior of the system preferably includes a power-up mode, a seek mode, and an operational mode. On power-up the system performs a number of self diagnostics and then clears any counters and control variables. It will then place itself into the SEEK mode.

In seek mode the board will set lowest bandwidth mode. If the device is a slave, it will continually listen until it has received an OAM startup message (it will disregard all others. If the device is configured as a master, it will transit OAM startup messages. Once the slave has successfully received the startup message, it will reply with a startup reply messages. The Master will then send another startup message that instructs the slave to ascend to a given transmit rate (binary tree method to be used). At the new level, the slave will listen and the master will send the startup message again. If both sides receive the message without error, they will perform this operation until the highest baud rate is achieved. In later release, actual line test (such as impulse/step response) will be performed that will allow iterative processing in order to determine optimal frequency AND to determine, and compensate for, reflections from bridge taps.

When the master is done setting the operational frequency between the boards, it will issue the first OAM termination message that starts the Ping-Pong operation of the system. When a side receives a termination message it knows that it has control of the lines and it knows how many cells it can send. The number of data cells sent would be the lesser of the SpaceA byte just received or the number of cells it has in its FIFO. When a side is finished sending (if it had any information to send) it will send a termination message with the amount of space remaining in its FIFO to the other side, and the process repeats.

During normal operation, if either side does not detect an OAM termination message within a configurable period of time (HbtTimeout), then that side will drop back to seek mode. The period preferably should be no longer than 1.5 times the amount of time for a side to empty its buffer when the buffer is full.

Silence is preferably declared on a line (TIP or RING) when there are eight consecutive bit cycles without a transition. The Silence State is maintained as long as there are no transitions on the line. There are two types of silence TRUE silence and FALSE silence.

A TRUE silence condition is detected when the potential of the line is at a “zero volt” condition for the first eight bit cycles of the silence period. The “zero volt” condition for TRUE silence is when the voltage is no more than 25% of the magnitude of the trapezoids. True silence is used to delineate the space between frames (much the same way as Flag symbols in HDLC). Between Frames, TRUE silence is transmitted on one line only allowing the other line to provide synchronization. TRUE silence is transmitted on both lines when a transmitter relinquishes control of the lines to the opposite side. This occurs after the OAM termination message is sent. This technique provides redundant signaling.

A FALSE silence condition is detected when line is not at the “zero volt” conditions for the entire eight bit cycles of the silence declaration period. Preferably, FALSE silence is not sent during normal operation for any signaling purpose. A condition of the lines similar to FALSE silence is used during line testing to measure the “Droop” of the line when a DC level is held. This measurement enables the TWISTR to determine the minimum switching rate of the line and, if desired, to pre-compensate for droop if needed at very long line lengths.

Each frame is preferably terminated with TRUE silence. The termination is performed in the next bit period after the last bit of the CKSUM byte is transmitted. Since the purpose of the termination it to set the line potentials to zero, there is no need to stagger the transitions. FIG. 61 is a diagram illustrating the frame termination to TRUE silence wherein ‘S’ denotes silence and ‘T’ denotes the termination cycle.

The space between frames provides a means to recover from catastrophic loss of sync. The conditions between frames preferably is unique and provides efficient startup synchronization when a frame begins. FIG. 62 depicts an embodiment of signals between frames. In an embodiment, there are exactly eight silence states on the RING circuit. This forces the receiver into a SILENCE termination mode in the event it becomes hopelessly out-of-sync and is logging bits after the end of the frame was transmitted. In an alternative embodiment, the inter-frame time is shorten by using a coding violation to force termination within 3 bit periods instead of 15.

Noise margin is a value used to determine if the change detected between two samples is significant. If the difference between two samples is less than or equal to the detected noise on the line than it can be said that there was no change on the line. During Silence periods, the system continually samples the Differential amplifier output to arithmetically determine the noise margin. The noise margin is determined by reading samples over one bit period and computing the max-min of all the samples. This value is then saved. The process is completed for all the remaining bits in the silence period. The largest max-min of all the bit periods samples become the noise margin used for the next frame received. The system preferably responds if the measured noise margin is larger than the expected slope difference. In an alternative embodiment, signal averaging is used to reduce noise because of the amount of oversampling that can be performed.

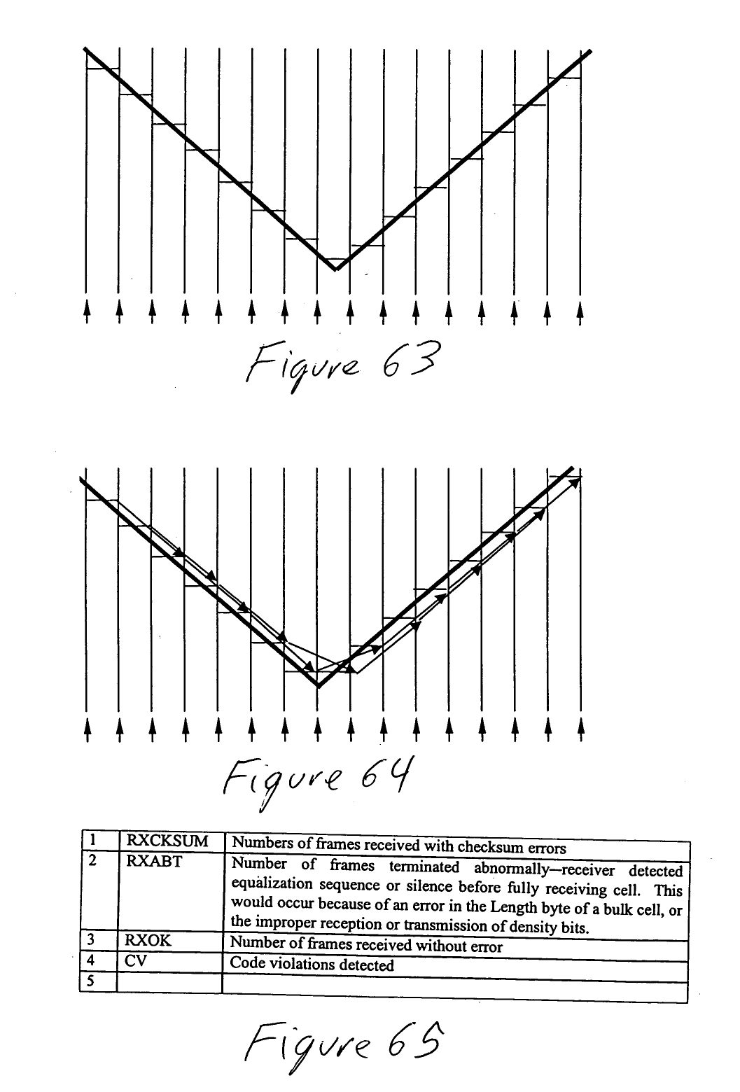

Turning to FIGS. 63 and 64, slope detection is preferably by a sampling. However, other commonly know methods can be used. Preferably, a FPGA performs a minimum eight times oversampling of the differential amplifier output. That is, there will be at least eight samples taken within each bit period. Two samples (A and B) are taken in the first half of the bit periods and two samples (C and D) are taken in the second half of the bit period.

Preferably, in an embodiment, counters are kept by the PIC processor for interrogation network managing elements as depicted in FIG. 65.

As stated above, in an embodiment, a two-wire system is created for a wireless system with different signals on each wire. This enables a parallel time shifted current modulation process. The system provides for parallel time shifting because the peak of the two pulses are in different time position, the slope of the two pulses are different, the bits on the slopes are different in time positions but the start of the two pulses and the end of the two pulses are in the same time positions.

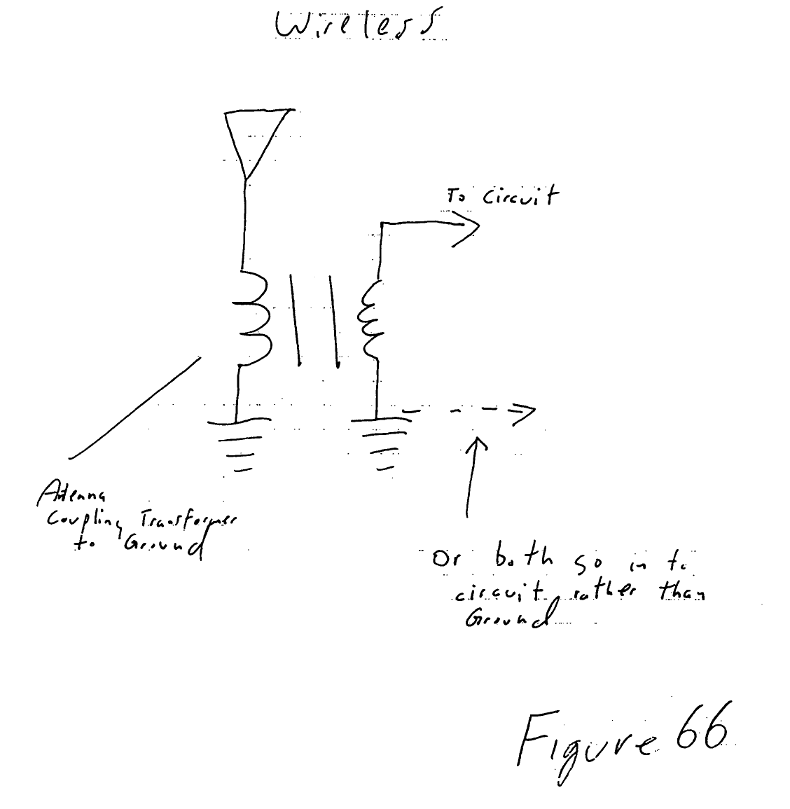

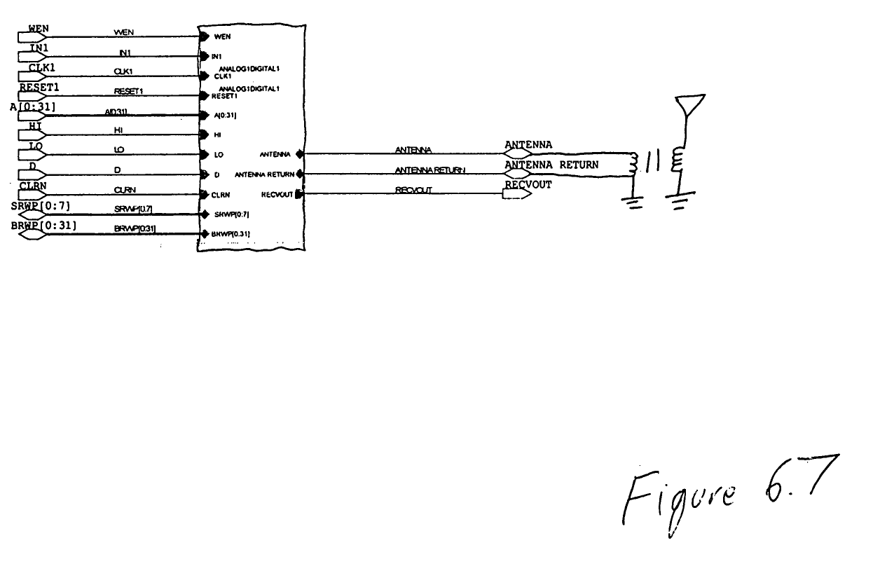

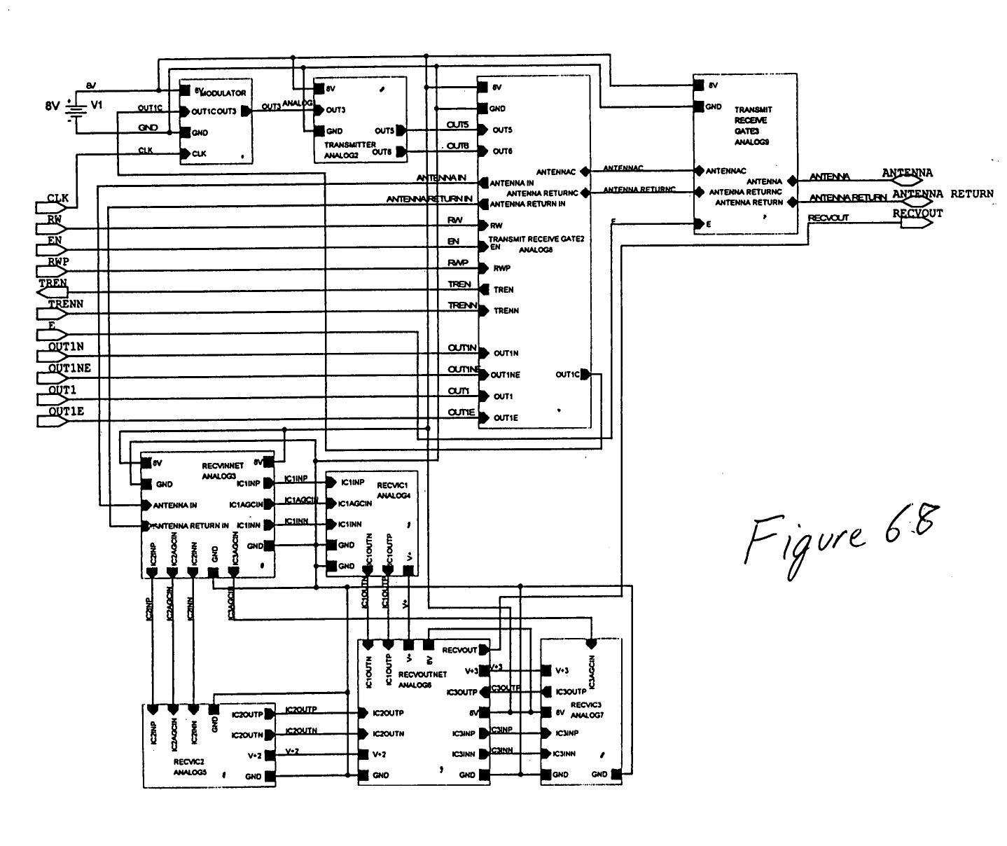

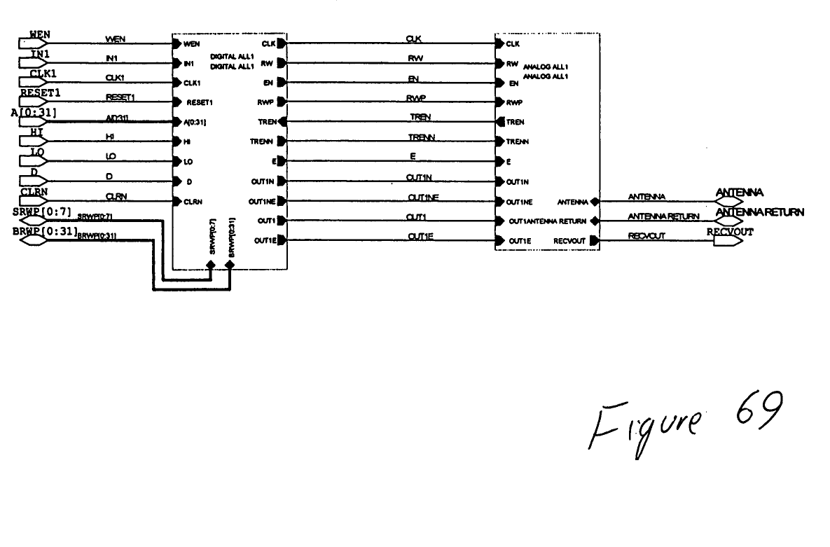

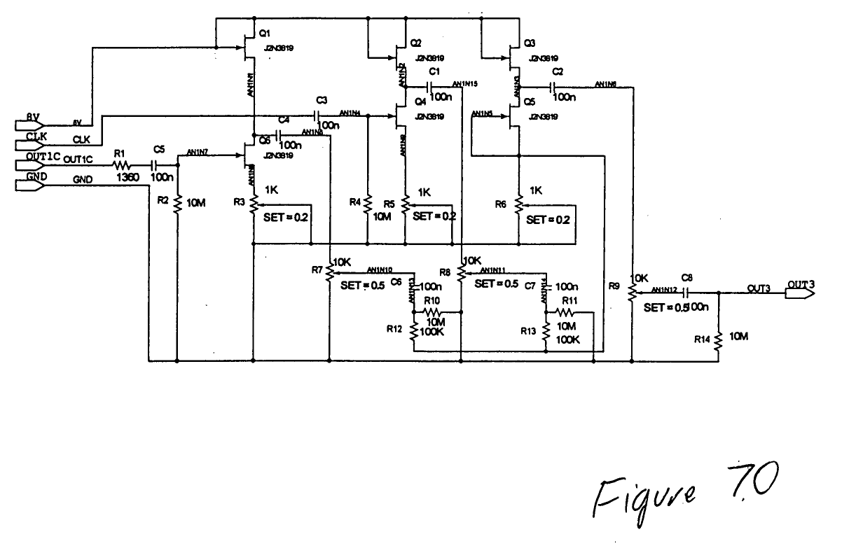

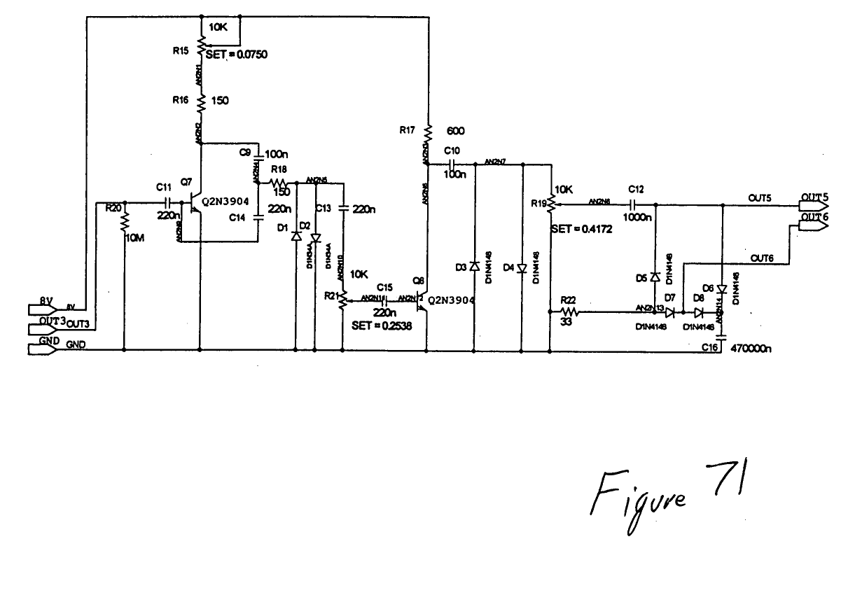

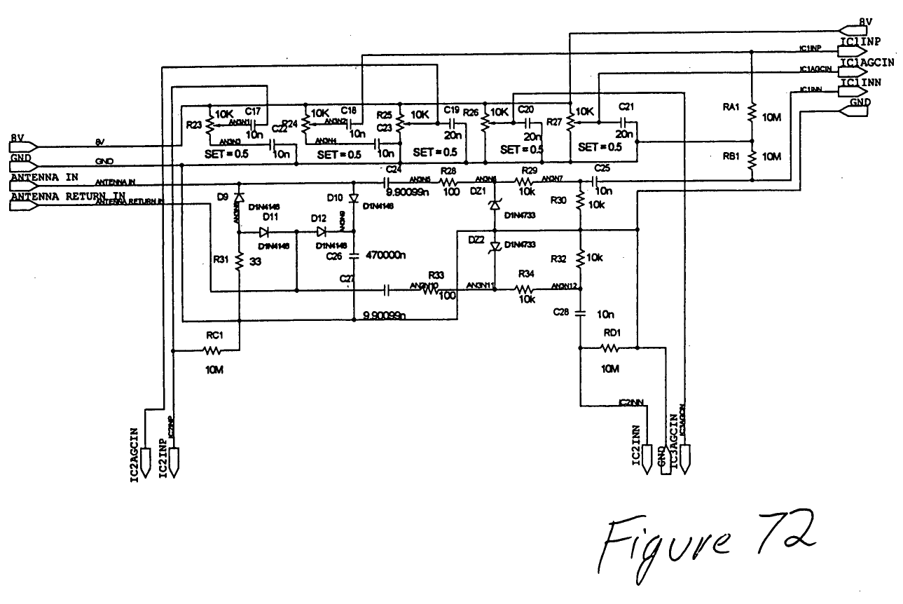

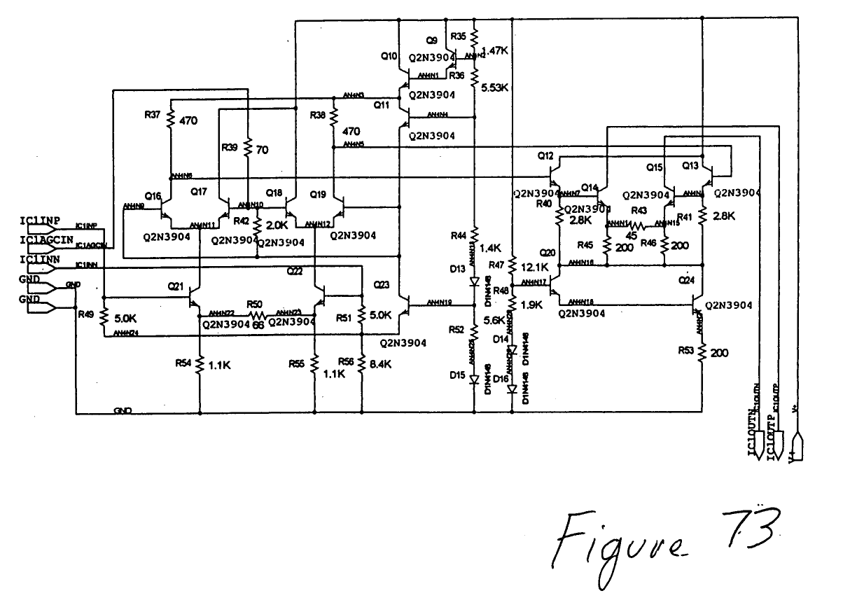

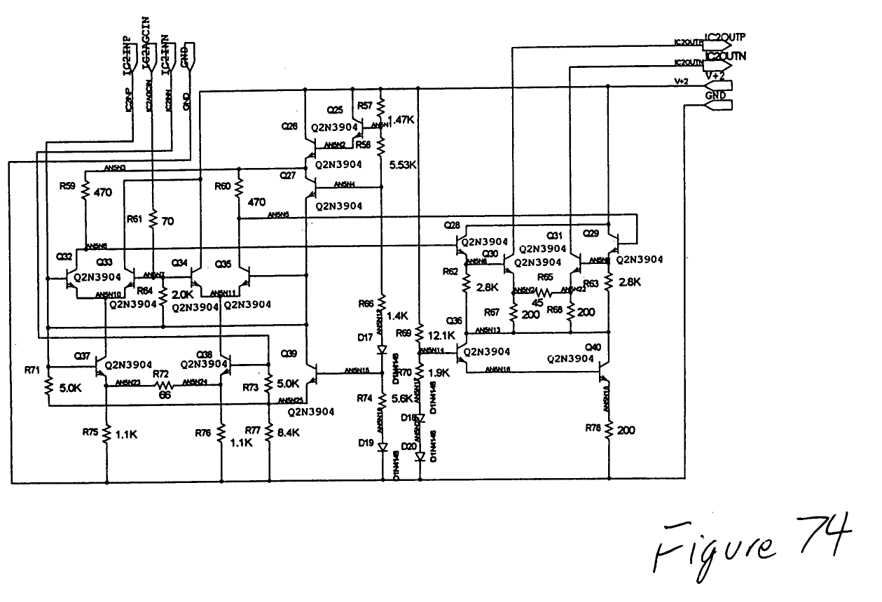

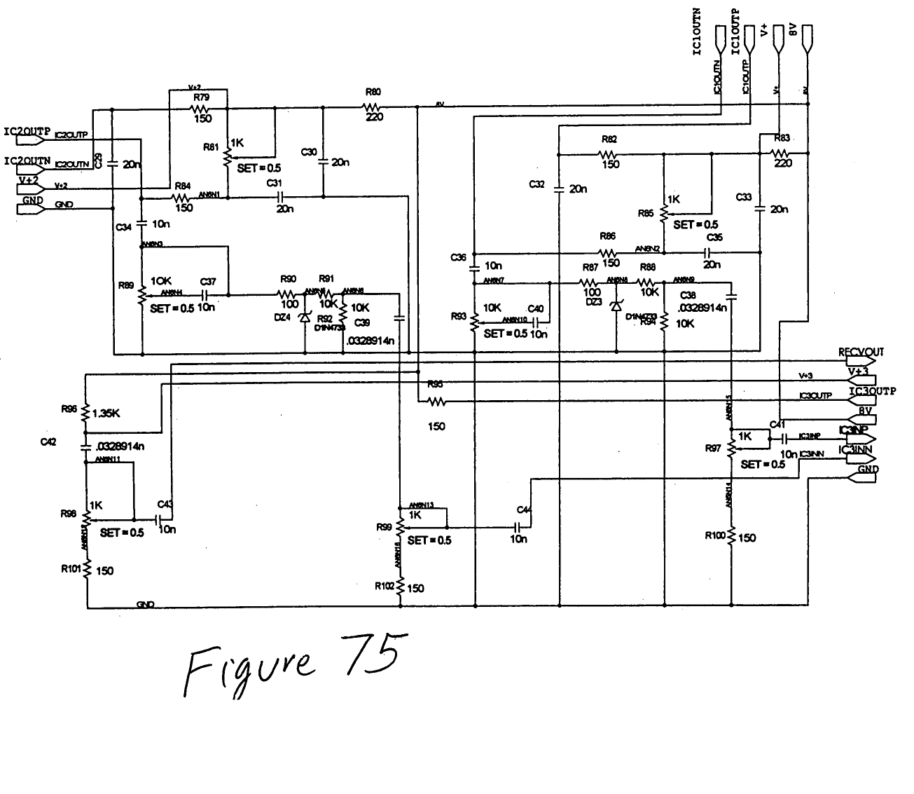

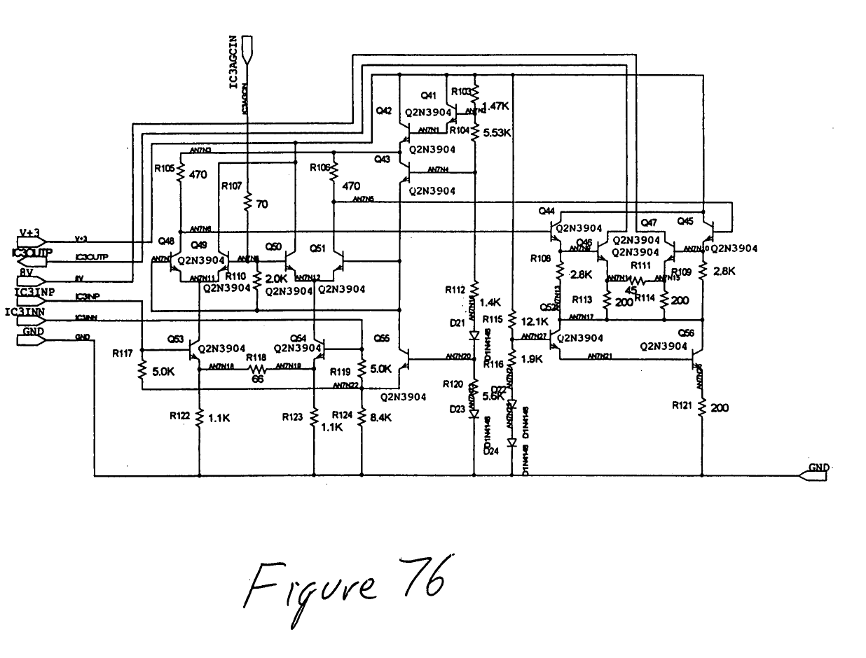

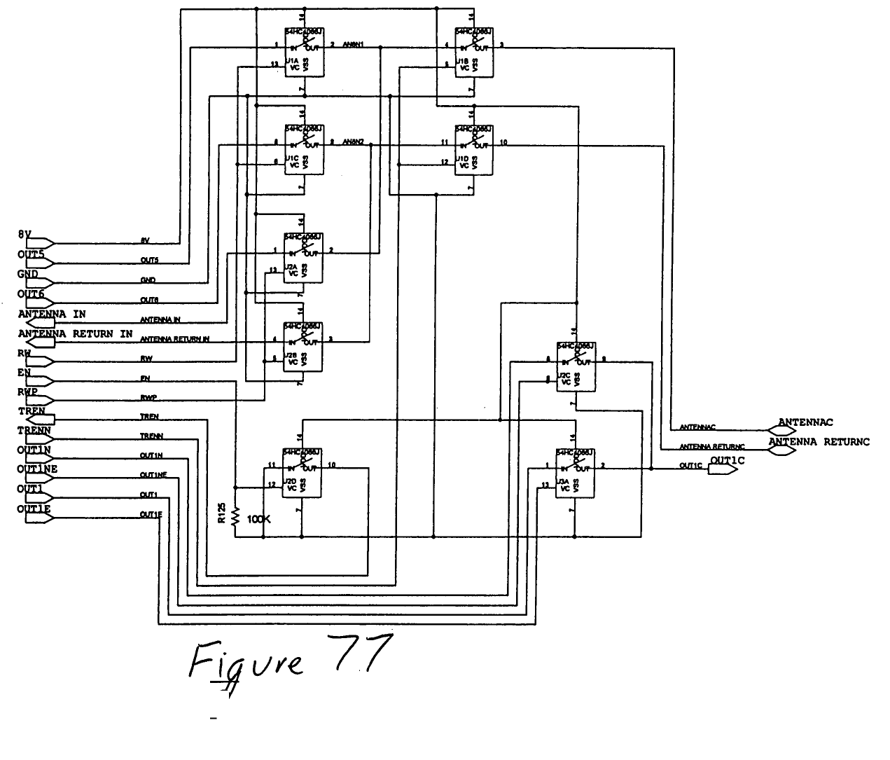

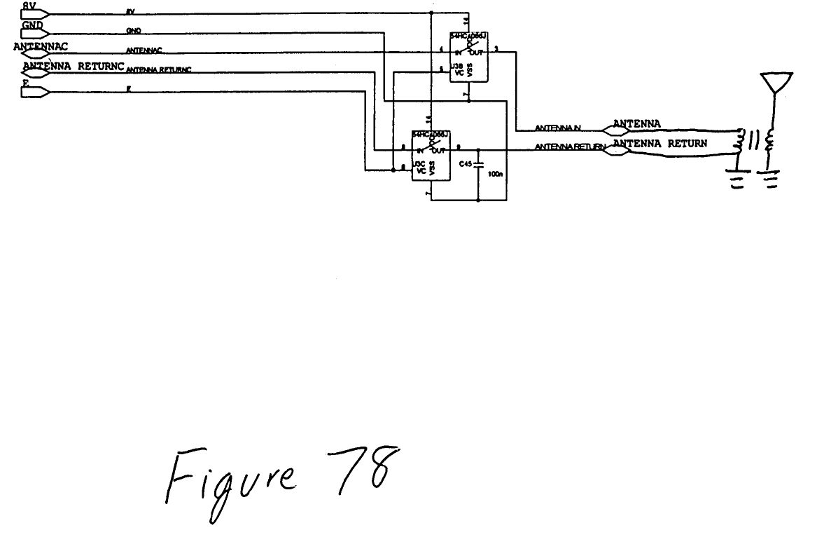

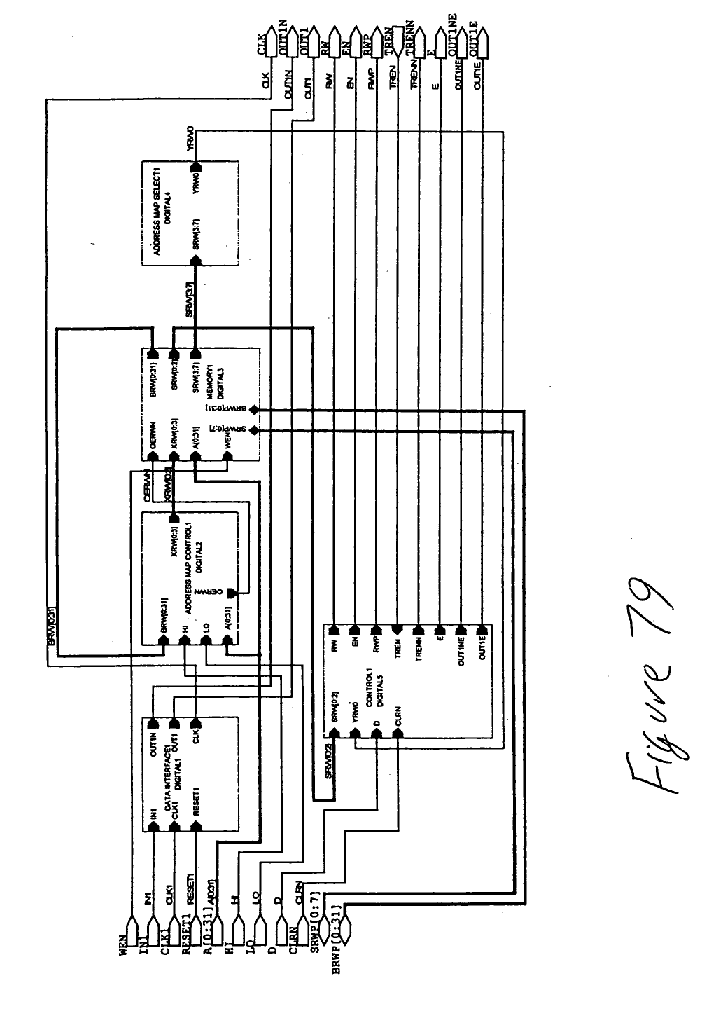

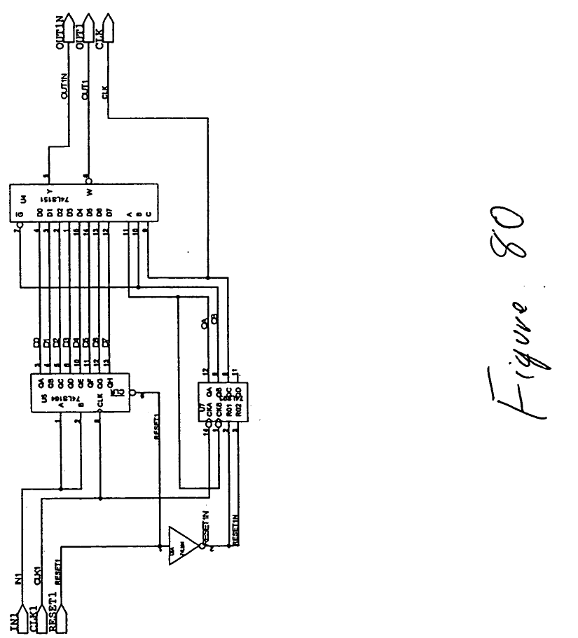

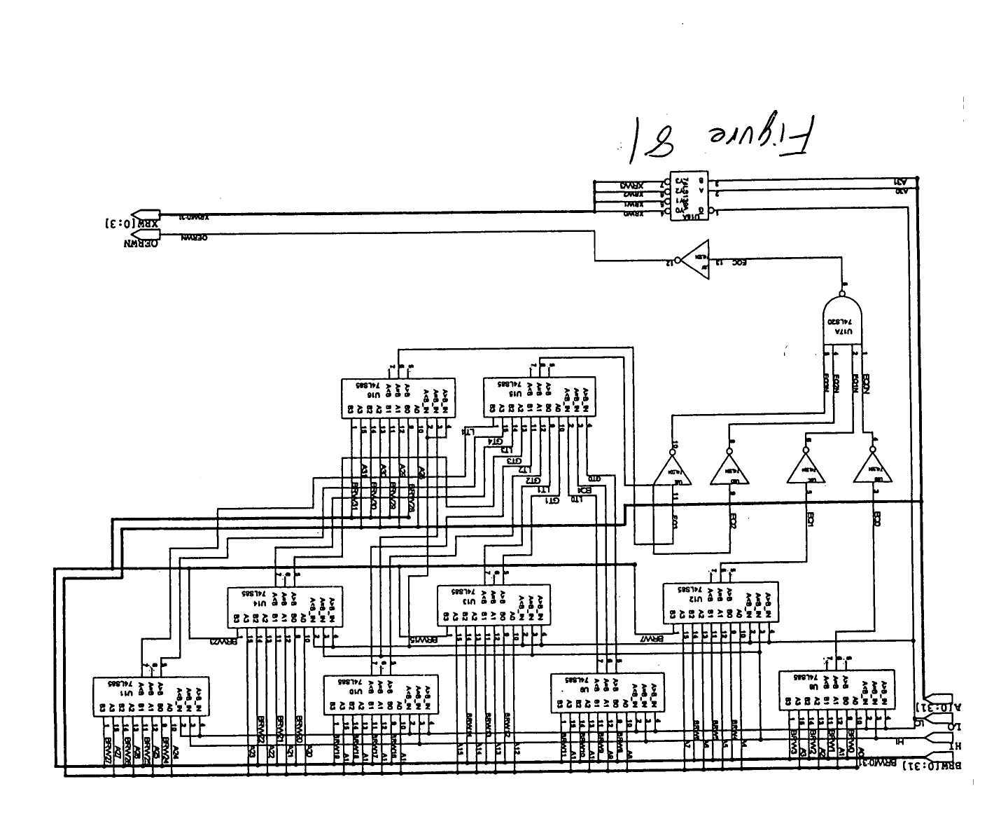

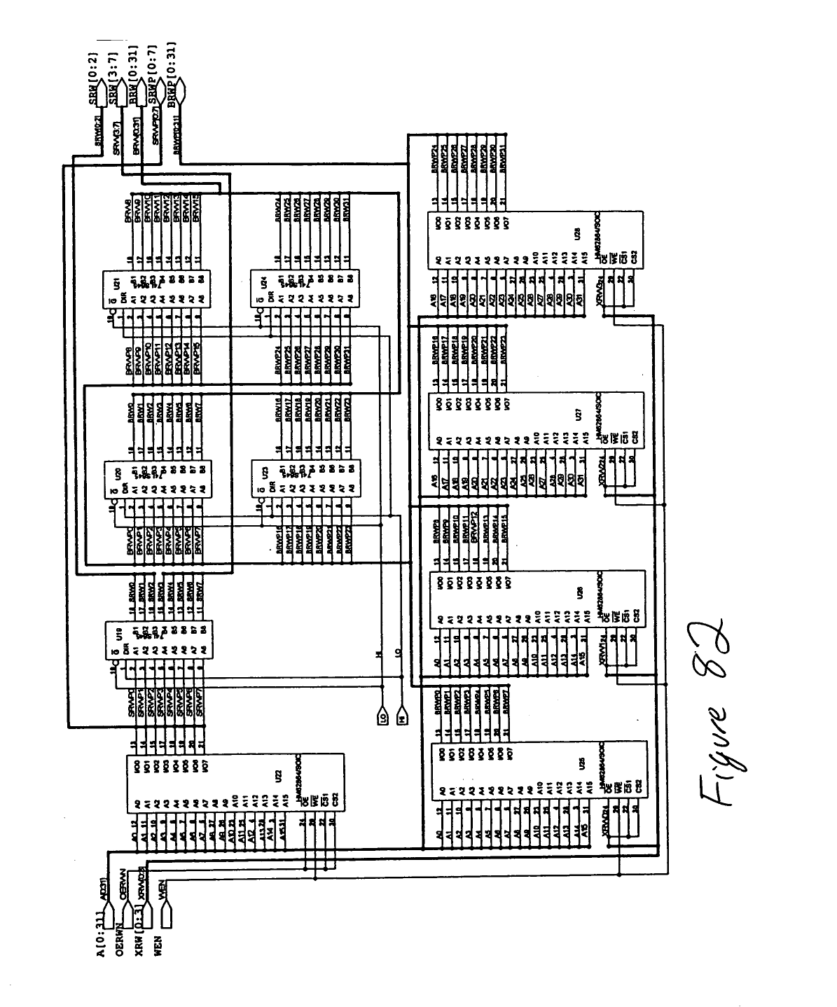

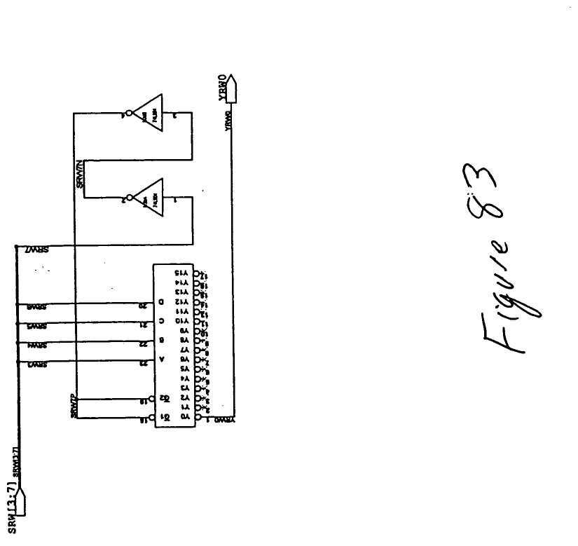

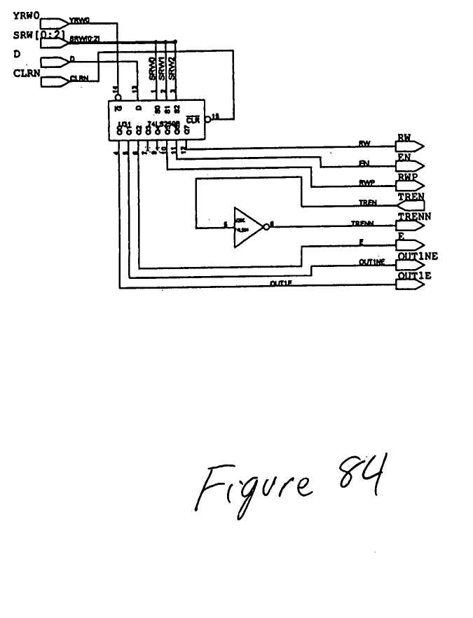

Turning to FIGS. 66-68, a simplified diagram and block diagrams are depicted of another embodiment of a system in accordance with the present invention. The system includes a data transmitter device, a wireless data transmission medium such as air, and a data receiver. The data receiver receives data signals transmitted from the transmitter across the wireless data transmission medium.

Turning to FIG. 71, the single ended output of the transmitter is converted to a dual ended output by the transmitter output network (i.e., D5, D6, D7, D8, R22, and C16), the output 5 is connected through transgates 2 and 3 to the antenna and out 6 is connected through transgates 2 and 3 through an antenna return to C45 to ground. Thus, wireless transmission of a signal is provided.

Turning to FIG. 68, the single ended input of the transmitter is converted to a dual ended input the recvinnet, antenna IN is connected through thrasgates 2 and 3 to the Antenna and Antenna Return IN is connected through transgates 2 and 3 through an Antenna Return to C45 to ground, the equivalent of a 2-wire system is created with a resultant current flow from Antenna through Antenna Return to C45 to ground. Thus, a wireless transmission signal is received.

It should also be understood that only preferred embodiments of the present methods and circuits are described herein. It is intended that changes and modifications may be made in the embodiments disclosed without departing from the true scope and spirit of the present invention as defined by the appended claims. It should also be understood that features, structure, and functions discussed within regard to an embodiment can be interchangeably incorporated into another embodiment also described herein.

What is claimed is:

1. A method of transmitting a voltage signal waveform as a series of current pulses onto a communication line comprising the steps of:
converting an input voltage signal waveform to a non-differential current signal waveform;
providing a predetermined substantially constant voltage;
transmitting said non-differential current pulses in response to said current signal waveform onto said communication line having a plurality of wires; and
maintaining a bias voltage on said communication line having an undetermined impedance while transmitting said non-differential current pulses.

2. The method of claim 1 further including the step of filtering said current signal waveform before the step of transmitting said current pulses.

3. The method of claim 2 wherein said filtering step further includes,
receiving said current signal waveform between a pair of oppositely biased diodes, each diode having two ends, first ends of said pair of oppositely biased diodes receptive to said current signal waveform, second ends of said pair of oppositely biased diodes connected to ground; and
differentiating said current signal waveform, said differentiator having two ends, first end of said differentiator coupled to first ends of said pair of oppositely biased diodes, and second ends of said differentiator connected to a capacitor.

4. The method of claim 1 further including the step of amplifying said current signal waveform before the step of transmitting said current pulses.

5. The method of claim 1 wherein the step of maintaining said bias voltage further includes the steps of:
providing a transmitter circuit with an adjustable impedance, said transmitter circuit being connected to said communication line;
measuring an impedance of said communication line by signals emanating from said transmitter circuit; and,
adjusting said impedance of said transmitter circuit based upon said measurement to provide said biased voltage on said communication line during transmission of said current pulses.

6. The methods of claim 5 wherein said measuring step further includes the steps of transmitting at least one reference/calibration pulse over said communication line and measuring the effects of line impedance on said current pulse.

7. The method of claim 1 further including the step of providing a receiver adapted to detect and measure said current pulses.

8. The method of claim 1 further including the steps of
providing a data input connected to a transmitter circuit having a capacitor in series with a variable resistor; and
converting said voltage pulses from the input into said current pulses for transmission.

9. The method of claim 1 wherein said bias voltage is maintained at about one (1) volt.

10. A method of transmitting a data signal over a communication line comprising:
generating non-differential pulses of current representative of data to be transmitted;
transmitting the non-differential current pulses over said communication line having an undetermined impedance;
providing a remote receiver adapted to receive said non-differential current pulses and to detect and measure current generated by said non-differential current pulses to translate the measured current into data.

11. The method of claim 10 including the steps of:
generating reference current pulses and transmitting them over the communication line; and,
receiving the reference pulses and adjusting said receiver to detect and measure current from said voltage pulses generated to be representative of data.

12. A circuit for transmitting an input voltage signal waveform as a series of non-differential current pulses onto a communication line comprising:
a converter for receiving said input voltage signal waveform and generating an output in response thereto; and
a transmitter responsive to said output of said converter for transmitting said series of non-differential current pulse signals on said communication line having an undetermined impedance.

13. The circuit of claim 12 further comprising a filter operably connected between said converter and said transmitter.

14. The circuit of claim 12 further comprising an amplifier operably connected between said converter and said transmitter.

15. The circuit of claim 12 wherein said converter includes,
a first common emitter transistor;
first, second and third capacitors, each having two ends;
first end of said first capacitor receptive to said input voltage signal waveform;
second end of said first capacitor and first end of said second capacitor coupled to base of said first common emitter transistor;
a resistor coupled between a collector of said first common emitter transistor and a voltage input;
first end of said third capacitor coupled to said collector of said common emitter transistor and said second end of said third capacitor coupled to said second end of said second capacitor; and
a resistor coupled to said second end of said second and third capacitors.

16. The circuit of claim 13 wherein said filter includes,
a pair of oppositely biased diodes having two ends;
first end of said pair of oppositely biased diodes operably connected to said converter;
a differentiator operably connected to second ends of said pair of oppositely biased diodes; and
a capacitor coupled between said differentiator and said amplifier.

17. The circuit of claim 16 wherein said differentiator comprises a capacitor in series with a variable resistor.

18. The circuit of claim 14 wherein said amplifier includes,
a second common emitter transistor having a collector coupled to said transmitter;
a resistor connected to a voltage input, said resistor also connected to said collector of said second common emitter transistor and said transmitter; and
base of said second common emitter transistor receptive to said current signal waveform.

19. The circuit of claim 15 wherein said transmitter includes,
a first capacitor having a first end and a second end, said first end operably connected to said amplifier;
a pair of oppositely biased diodes having two ends;
first end of said pair of oppositely biased diodes coupled between second end of said first capacitor and ground;
a variable resistor having two ends;
first end of said variable resistor coupled to second end of said first capacitor and said first ends of said pair of oppositely biased diodes; and,
a second capacitor having two sides, first side of said second capacitor coupled to second end of said variable resistor, wherein said second end of said second capacitor is connected to the communication line.

20. A circuit for transmitting an input voltage signal waveform as a series of current pulses, comprising, in combination:
a first and second common emitter transistor;
a first, second, third, fourth, fifth, sixth and seventh capacitor, each having two ends;
a first, second and third variable resistor, each having two ends;
a first and second resistor, each having two ends;
a first and second pair of oppositely biased diodes, each pair having two ends;
first end of said first capacitor receptive to said input voltage signal waveform;
second end of said first capacitor and first end of said second capacitor coupled to base of said first common emitter transistor;
first variable resistor coupled between collector of said first common emitter transistor and a voltage input;
first end of said third capacitor coupled to said collector of said first common emitter transistor and said second end of said third capacitor coupled to said second end of said second capacitor; and,
first end of said resistor commonly coupled to said second end of said second and third capacitors;
first end of said first pair of oppositely biased diodes operably connected to second end of said second resistor and first end of said fourth capacitor;
second end of said fourth capacitor connected to first end of said second variable resistor;
first end of said fifth capacitor coupled between second end of said second variable resistor and base of said second common emitter transistor;
first end of said second resistor coupled to said voltage input;
second end of said second resistor coupled between collector of said second common emitter transistor and first end of said sixth capacitor;
first end of said second pair of oppositely biased diodes coupled to second end of said sixth capacitor;
first end of said third variable resistor coupled to second end of said sixth capacitor and said first ends of said second pair of oppositely biased diodes; and,
first end side of said seventh capacitor coupled to second end of said third variable resistor, wherein said second end of said seventh capacitor is connected to said communication line.

21. The circuit of claim 20 further comprising a receiver operably connected to said transmitter via said communication line.

22. A method of transmitting as a series of current pulses onto a communication line comprising the steps of:
converting data into non-differential current pulses; and,
transmitting said non-differential current pulse signals onto said communication line having an undetermined impedance.

23. The method of claim 22 wherein the communication line includes tip and ring wires.

24. The method of claim 22 further including the step of applying a predetermined voltage to bias said communication line during transmission.

25. The method of claim 24 further including the step of applying a predetermined voltage to bias said communication line during transmission.

26. The method of claim 25 further including the step of varying a power input to said bias voltage to maintain said bias voltage on said communication line substantially constant during transmission of said current pulses.

27. The method of claim 22 further including the steps of:
converting an input voltage signal waveform to a current signal waveform;
providing a predetermined substantially constant voltage; and,
transmitting said current pulses in response to said current signal waveform onto said communication line.

28. The method of claim 27 further including the steps of:
applying a predetermined voltage to bias said communication line during transmission; and,
varying a power input to said bias voltage to maintain said bias voltage on said communication line substantially constant during transmission of said current pulses.

29. The method of claim 27 further including the step of filtering said current signal waveform before the step of transmitting said current pulses.

30. The method of claim 22 further including the step of providing a receiver adapted to detect and measure said current pulses.

31. A method of transmitting as a series of non-differential current pulse signals onto a communication line comprising the steps of:
converting data into non-differential current pulses;
transmitting said non-differential current pulses onto said communication line having tip and ring wires and an undetermined impedance; and,
providing a remote receiver adapted to decipher said non-differential current pulses into said data.

32. A data communications method comprising the steps of:
providing a reference voltage potential;
providing a termination impedance operably connected to said reference voltage potential;
providing a variable control impedance operably connected to said termination impedance and a communications line;
varying said variable control impedance in response to a voltage input data signal;
detecting variations in current on the communications line in response to varying said variable control impedance.

33. The data communications method of claim 32 further including the steps of providing another reference voltage operably connected to the communications line and maintaining a substantially constant impedance value between the reference voltages.

35. A method of transmitting a voltage signal waveform as a series of current pulses onto an antenna and over a wireless communications medium comprising the steps of:
converting an input voltage signal waveform to a current signal waveform;
providing a predetermined substantially constant voltage;
transmitting said current pulses in response to said current signal waveform onto said antenna; and,
maintaining a bias voltage on said antenna while transmitting said current pulses.

36. The method of claim 35 further including the step of filtering said current signal waveform before the step of transmitting said current pulses.

37. The method of claim 36 wherein said filtering step further includes,
receiving said current signal waveform between a pair of oppositely biased diodes, each diode having two ends, first ends of said pair of oppositely biased diodes receptive to said current signal waveform, second ends of said pair of oppositely biased diodes connected to ground; and,
differentiating said current signal waveform, said differentiator having two ends, first end of said differentiator coupled to first ends of said pair of oppositely biased diodes, and second ends of said differentiator connected to a capacitor.

38. The method of claim 35 further including the step of amplifying said current signal waveform before the step of transmitting said current pulses.

39. The method of claim 35 wherein the step of maintaining said bias voltage further includes the steps of:
providing a transmitter circuit with an adjustable impedance, said transmitter circuit being connected to said antenna;
measuring an impedance of said antenna by signals emanating from said transmitter circuit; and,
adjusting said impedance of said transmitter circuit based upon said measurement to provide said biased voltage on said antenna during transmission of said current pulses.

40. The method of claim 35 further including the step of providing a receiver adapted to detect and measure said current pulses.

41. The method of claim 35 wherein said bias voltage is maintained at about one (1) volt.

42. A method of transmitting a data signal via a wireless connection comprising:
generating pulses of current representative of data to be transmitted;
transmitting the current pulses onto an antenna;
providing a remote receiver adapted to receive said current pulses and to detect and measure current generated by said voltage pulses to translate the measured current into data.

43. A method comprising the steps of:
applying a pair of input signals to a differential amplifier to generate a reconstructed data transmission signal; and
extracting originally transmitted information from the reconstructed data transmission signal.

44. The method of claim 43 further comprising the steps of:
identifying bit boundaries within the reconstructed data transmission signal; and
utilizing the bit boundaries to perform synchronization.

45. The method of claim 44 further comprising the step of identifying sampling points based, at least in part, on the identified bit boundaries.

46. The method of claim 45 further comprising the step of performing slope detection on the reconstructed data signal at the sampling points.

47. The method of claim 46 further comprising the step of extracting data based upon the detected slopes.

48. The method of claim 43 further comprising the steps of:
inserting a data signal into at least one of the pair of input signals; and
utilizing the data signal to maintain a minimum rate of transition.

49. A method comprising the steps of:
packetizing information transmitted across a transmission medium by a controlled current source; and
including within the packetized information a frame.

50. The method of claim 49 further comprising the step of providing cell data transport information within the frame.

51. The method of claim 49 further comprising the step of providing bulk data transport information within the frame.

52. The method of claim 49 further comprising the step of providing operation and maintenance message within the frame.

53. The method of claim 52 further comprising the step of providing a startup message within the operation and maintenance message.

54. The method of claim 52 further comprising the step of providing a termination message within the operation and maintenance message.

55. A method comprising the steps of:
performing a self diagnostic on a device that transmits information across a transmission medium by utilizing a controlled current source;
determining a rate to transmit the information across the transmission medium; and
transmitting the information across the transmission medium.

56. A method comprising the steps of:
detecting a period wherein there are no transitions on a transmission line; and
determining whether a true silence condition exists during the period.

57. The method of claim 56 wherein the step of determining whether a true silence condition exists includes determining whether the transmission line has voltage below a predetermined threshold.

58. The method of claim 56 further comprising the step of terminating a frame during a true silence condition.

59. The method of claim 56 further comprising the step of determining a noise margin on the transmission line during a true silence condition.

60. A method of using a twisted pair for independent signaling comprising the steps of:
generating a plurality of digital signals using a controlled current source having an output; and
encoding the digital signals.

61. The method of claim 60 wherein the step of encoding the digital signals includes ramping the output of the controlled current source in response to receiving a binary “1” as one of the digital signals.

62. The method of claim 60 further comprising the step of transmitting the digital signals across a pair of electrical leads.

63. The method of claim 60 further comprising the step of transmitting the digital signals across a pair of electrical leads by alternately sending the signals and listening for return signals.

64. The method of claim 60 further comprising the step of transmitting the digital signals across a pair of electrical leads at a rate of about 12.5 Megabits/sec at about 6000 feet.

65. A method comprising the steps of:
generating a plurality of digital signals using a device having a plurality of controlled current sources, each of the current sources having an output; and
encoding the digital signals on a pair of electrical leads.

66. The method of claim 65 wherein the step of encoding the digital signals includes ramping the output of the controlled current source in response to receiving a binary “1” as one of the digital signals.

67. The method of claim 65 further comprising the step of alternating the digital signals between the pair of electrical leads.

68. The method of claim 65 further comprising the step of transmitting the digital signals across the pair of electrical leads at a rate of about 12.5 Megabits/sec at about 6000 feet.

69. The method of claim 65 further comprising the steps of:
applying the digital signals to differential amplifier to generate a reconstructed data transmission signal; and
extracting originally transmitted information from the reconstructed data transmission signal.

70. The method of claim 69 further comprising the steps of:
identifying bit boundaries within the reconstructed data transmission signal; and
utilizing the bit boundaries to perform synchronization.

70. The method of claim 69 further comprising the step of identifying sampling points based, at least in part, on the identified bit boundaries.

71. The method of claim 71 further comprising the step of performing slope detection on the reconstructed data signal at the sampling points.

72. The method of claim 72 further comprising the step of extracting data based upon the detected slopes.

73. The method of claim 65 further comprising the steps of:
performing a self diagnostic on the device; and
determining a rate to transmit across the electrical leads.

74. A method of transmitting data over a communication line having a longitudinal impedance comprising the steps of:
transmitting a signal onto the line including data;
determining the data from measurement of at least one component of the line's impedance over at least a portion of the line's longitudinal impedance proximate a receiving end of the line.

75. The method of claim 74 including:
providing a reactive component to the line proximate the receiving end of the line and adding to the impedance thereof, and the measurement being made relative to the added reactive component.

76. The method of claim 75 wherein the reactive component is a resistor and the component of impedance measured is voltage.

77. The method of claim 74 including that the measurement includes detection of a slope of signal elements.

78. The method of claim 77 including that the measurement includes detection of a slope of signal elements.

79. The method of claim 76 including that the voltage is between the line and a low charge reference point proximate a receiving end of the line.

80. The method of claims 74 wherein the transmitting step includes transmitting over 1000 feet of line.

81. The method of claims 79 wherein the transmitting step includes transmitting over 1000 feet of line.

82. The method of claim 74 including the step of providing a second transmission line configured in close proximity to the second and transmitting a signal onto the second line including data; and, determining the data from measurement of at least one component of the line's impedance over at least a portion of the line's longitudinal impedance proximate a receiving end of the second line.

83. The method of claims 82 wherein the transmitting steps include transmitting over 1000 feet of each line.

84. A method of transmitting data over a communication line having a longitudinal impedance comprising the steps of:
transmitting a signal onto the line including data; and,
determining the data from measurement of a voltage referenced between the line and a low charge reference point proximate a receiving end of the line.

85. The method of claim 84 wherein the low charge reference point is a ground relative to the receiving end of the line.

86. The method of claim 84 wherein the communication line is physically coupled as a twisted pair with a second transmission line.

87. The method of claim 86 including:
transmitting a separate signal onto the second line including data; and,
determining the data from measurement of a voltage referenced between the second line and a low charge reference point proximate a receiving end of the second line.

88. The method of claim 87 including comparison of the measured voltages between the first and second lines and generating at least one derived data signal.

89. The method of claim 88 wherein the comparing step includes subtracting the two voltage signals.

90. The method of claims 84 wherein the transmitting step includes transmitting over 1000 feet of line.

91. The method of claims 89 wherein the transmitting step includes transmitting over 1000 feet of line.
